(19) United States
(12) Patent Application Publication
(10) Pub. No.: US 2026/0314748 A1
(43) Pub. Date: Oct. 15, 2026

(54) Footwear Sole Structures and Articles of Footwear Including the Sole Structures

(71) Applicant: NIKE, Inc., Beaverton, OR (US)

(72) Inventors: Elysia M. Davis, Portland, OR (US); Kevin R. Derr, Portland, OR (US); Risha Dupre, Tigard, OR (US); Bryan Picco, Beaverton, OR (US); Rachel M. Savage, Beaverton, OR (US); Bryan K. Youngs, Beaverton, OR (US); James Zormeir, Portland, OR (US)

(21) Appl. No.: 19/641,927

(22) Filed: Apr. 8, 2026

Related U.S. Application Data
(60) Provisional application No. 63/786,037, filed on Apr. 9, 2025.

(51) Int. Cl. A43B 13/12; A43B 5/00

(52) U.S. Cl. CPC A43B 13/127; A43B 5/00

(57) ABSTRACT

Sole structures and footwear include: (i) a lower midsole component including a ground-facing surface and an opposite upper-facing surface and (ii) an upper midsole component also including a ground-facing surface and an opposite upper-facing surface. In at least some examples, the lower midsole component will be harder than the upper midsole component at least over some of a forefoot region of the sole structure. More specifically, the lower midsole component may be at least 4 Asker C durometer hardness points greater than the upper midsole component. Additionally or alternatively, such sole structures and/or footwear may include a rigid plate member located between the facing surfaces of the midsole components. The plate member may include a plantar support surface that tilts such that the lateral side edge is higher than the medial side edge at least in a portion of a forefoot region of the sole structure.

### RELATED APPLICATION DATA

This application is a U.S. Non-Provisional Application and claims priority benefits based on U.S. Provisional Patent Appln. No. 63/786,037, filed Apr. 9, 2025 and entitled “Footwear Sole Structures and Articles of Footwear Including the Sole Structures,” which application is entirely incorporated herein by reference.

### FIELD OF THE INVENTION

The present technology relates to footwear sole structures and/or articles of footwear that include the sole structures. Additional aspects of this technology relate to methods of making and using such sole structures and/or articles of footwear.

### BACKGROUND

Conventional articles of athletic footwear include two primary elements, an upper and a sole structure. The upper may provide a covering for the foot that securely receives and positions the foot with respect to the sole structure. In addition, the upper may have a configuration that protects the foot and provides ventilation, thereby cooling the foot and removing perspiration. The sole structure may be secured to a lower surface of the upper and generally is positioned between the foot and any contact surface. In addition to attenuating ground reaction forces and absorbing energy, the sole structure may provide traction and control potentially harmful foot motion, such as over pronation.

The upper forms a void on the interior of the footwear for receiving the foot. The void has the general shape of the foot, and access to the void is provided at an ankle opening. Accordingly, the upper extends over the instep and toe areas of the foot, along the medial and lateral sides of the foot, and around the heel area of the foot. A lacing system often is incorporated into the upper to allow users to selectively change the size of the ankle opening and to permit the user to modify certain dimensions of the upper, particularly girth, to accommodate feet with varying proportions. In addition, the upper may include a tongue that extends under the lacing system to enhance the comfort of the footwear (e.g., to moderate pressure applied to the foot by the laces). The upper also may include a heel counter to limit or control movement of the heel.

### SUMMARY

This Summary is provided to introduce some general concepts relating to this technology in a simplified form that are further described below in the Detailed Description. This Summary is not intended to identify key features or essential features of the invention.

Aspects of this technology relate to footwear sole structures and/or articles of footwear that include features for maintaining traction, e.g., during sharp and/or hard cutting actions, such as while playing basketball.

More specific aspects of this technology relate to sole structures and/or articles of footwear including: (i) a first midsole component including a first ground-facing surface and a first upper-facing surface located opposite the first ground-facing surface, wherein the first midsole component has a first hardness at least at a first location in a forefoot region of the sole structure; and (ii) a second midsole component including a second ground-facing surface that faces the first upper-facing surface and a second upper-facing surface located opposite the second ground-facing surface, wherein the second midsole component has a second hardness at least at a second location in the forefoot region of the sole structure. In at least some examples of this technology, the first hardness will be at least 4 Asker C durometer hardness points greater than the second hardness. Such sole structures and/or articles of footwear further may include a plate member, e.g., of the types described in more detail below.

Additional or alternative aspects of this technology relate to sole structures and/or articles of footwear including: (a) a first midsole component including a first ground-facing surface and a first upper-facing surface located opposite the first ground-facing surface, wherein the first upper-facing surface defines a receptacle; (b) a second midsole component at least partially received in the receptacle, the second midsole component including a second ground-facing surface that faces the first upper-facing surface and a second upper-facing surface located opposite the second ground-facing surface; and (c) a plate member at least partially received in the receptacle and located between the first upper-facing surface and the second ground-facing surface, wherein the plate member includes a plantar support surface having a lateral side edge and a medial side edge. In such structures, when the sole structure is supported upright with the bottom foot support surface thereof supported on a horizontal support surface in an unloaded condition, the plantar support surface of the plate member may be tilted such that the lateral side edge is higher in the sole structure than the medial side edge at least in a portion of a forefoot region of the sole structure. Such sole structures and/or articles of footwear may include midsole components having the different hardness features described above and/or the different hardness features and/or other features described in more detail below.

Still additional or alternative aspects of this technology relate to methods of making and/or using sole structures and/or articles of footwear, e.g., of the types described above and/or the types described in more detail below.

### BRIEF DESCRIPTION OF THE DRAWINGS

The foregoing Summary, as well as the following Detailed Description, will be better understood when considered in conjunction with the accompanying drawings in which like reference numerals refer to the same or similar elements in all of the various views in which that reference number appears.

FIGS. 1A and 1B illustrate example articles of footwear in accordance with aspects of this technology.

FIGS. 2-2I provide various views of an example midsole in accordance with some examples of this technology.

FIG. 3 provides a top plan view of the lower midsole component shown in the example of FIGS. 2-2J.

FIGS. 4A-4F provide various views of the upper midsole component shown in the example of FIGS. 2-2J.

FIGS. 5A-5E provide various views of the rigid plate member shown in the example of FIGS. 2-2J.

FIGS. 6-6P provide various views of another example midsole in accordance with some examples of this technology.

FIGS. 7A-7C are views illustrating potential features of sole structures and articles of footwear in accordance with at least some examples of this technology.

### DETAILED DESCRIPTION

In the following description of various examples of footwear structures and components according to the present technology, reference is made to the accompanying drawings, which form a part hereof, and in which are shown by way of illustration various example structures and environments in which aspects of the present technology may be practiced. It is to be understood that other structures and environments may be utilized and that structural and functional modifications may be made to the specifically described structures and methods without departing from the scope of the present disclosure.

“Footwear,” as that term is used herein, means any type of wearing apparel for the feet, and this term includes, but is not limited to: all types of shoes, boots, sneakers, sandals, thongs, flip-flops, mules, scuffs, slippers, sport-specific shoes (such as skateboarding shoes, golf shoes, tennis shoes, baseball cleats, soccer or football cleats, ski boots, basketball shoes, cross training shoes, dance shoes, etc.), and the like.

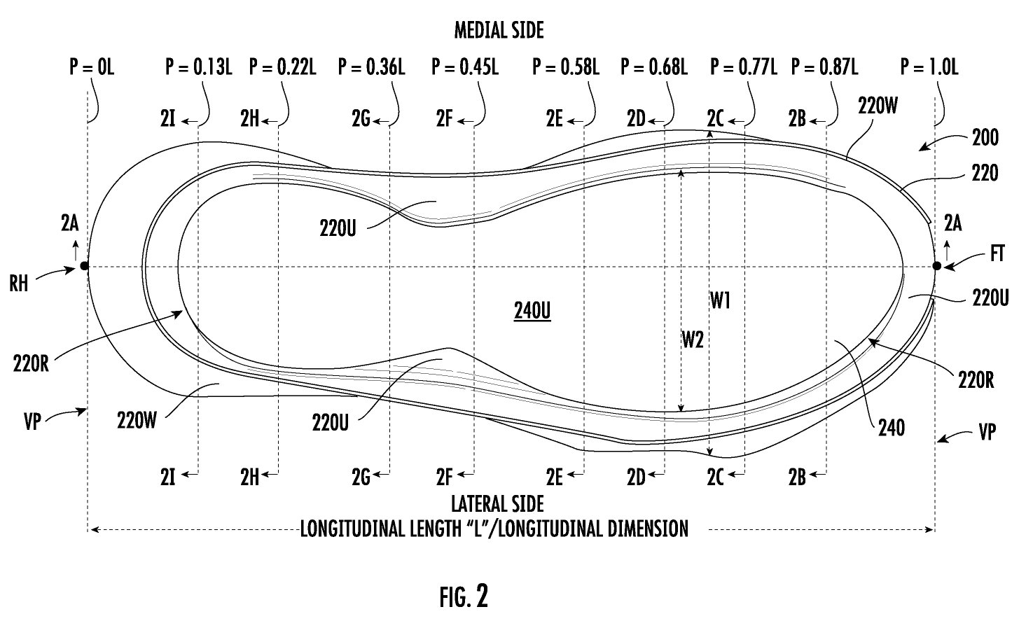

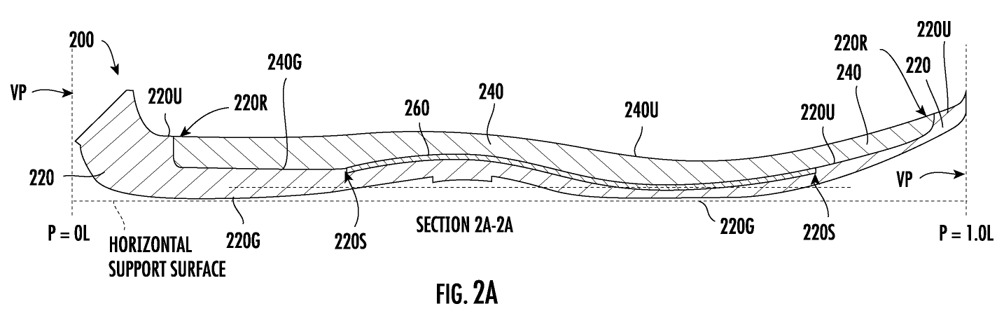

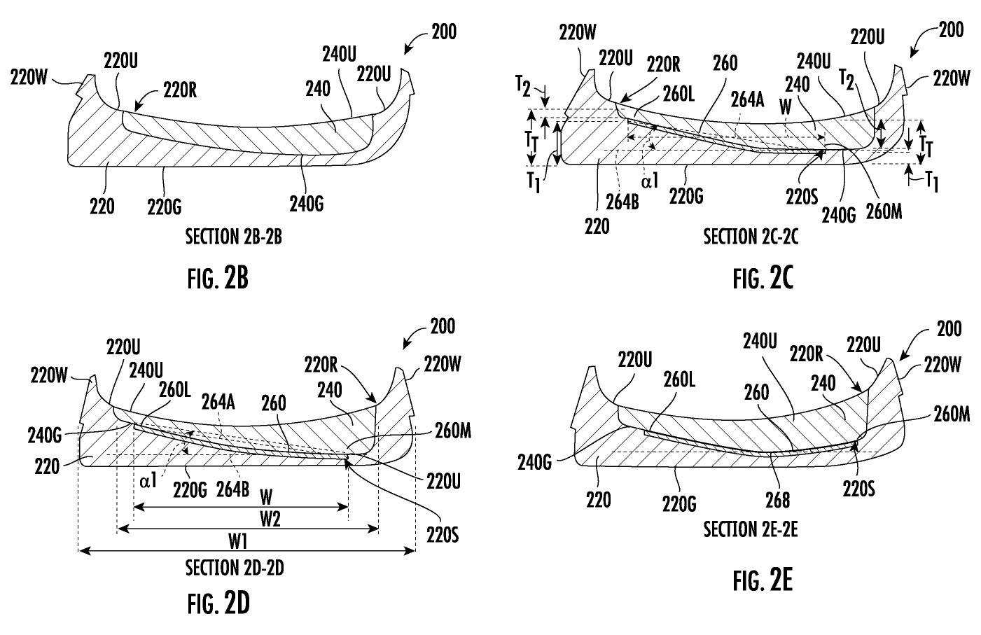

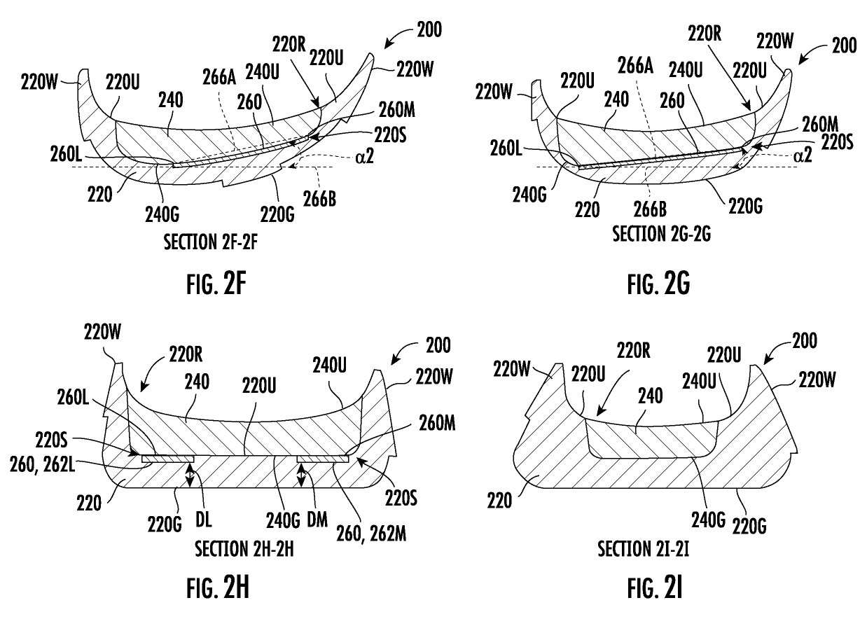

Various structures and parameters of footwear sole structures and/or articles of footwear are described herein based on a “longitudinal length” parameter L. Note FIG. 2. The longitudinal length L can be found with the article of footwear (or sole structure or other component) oriented on a horizontal support surface on its ground-facing surface in an unloaded condition (e.g., with no weight applied to it other than weight of other components of the article of footwear, sole structure, or other component). Once so oriented, parallel vertical planes VP that are perpendicular to the horizontal support surface are oriented to contact the rearmost heel (RH) location(s) and the forwardmost toe (FT) location(s) of the article of footwear, upper, sole structure, or another component of interest. The parallel vertical planes VP should be oriented facing one another, e.g., extending into and out of the page of FIG. 2, and as far away from one another as possible while still in contact with the rearmost heel RH and forwardmost toe FT locations. The direct distance between these vertical planes VPs corresponds to the longitudinal length L of the article of footwear, sole structure, or other component of interest. Locations of various footwear features and/or components are described in this specification based on their respective locations along the longitudinal length L as measured forward from the rear heel vertical plane VP. The rearmost heel (RH) location(s) is (are) located at position 0L and the forwardmost toe (FT) location(s) is (are) located at position 1L along the longitudinal length L. Intermediate locations along the longitudinal length L are referred to by fractional locations (e.g., 0.33L) along the longitudinal length L measured forward from the rear heel vertical plane VP. The term “parallel planes” as used herein are planes oriented parallel to the vertical planes VP. These parallel planes may intersect the longitudinal length L or longitudinal direction somewhere between P = 0L and P = 1.0L. Note FIG. 2, including various section lines 2B-2B through 2I-2I oriented at parallel planes.

The term “rearward” as used herein means at or toward the heel region of the article of footwear (or component thereof), and the term “forward” as used herein means at or toward a forefoot or forward toe region of the article of footwear (or component thereof). Unless otherwise defined, the terms “heel area” or “heel region” refer to a region bounded by parallel planes at 0L and 0.33L, the terms “midfoot area,” “midfoot region,” or “arch region” refer to a region bounded by parallel planes at 0.33L and 0.67L, and the terms “forefoot area” or “forefoot region” refer to a region bounded by parallel planes at 0.67L and 1.0L. Also, the term “lateral” means the “little toe” side or outside area of an article of footwear or component thereof (e.g., an upper, a sole structure, etc.), and the term “medial” means the “big toe” side or inside area of an article of footwear or component thereof (e.g., an upper, a sole structure, etc.).

This application and/or its claims may use the terms, e.g., “first,” “second,” “third,” and the like, to identify certain components and/or features relating to this technology. These terms are used merely for convenience, e.g., to assist in maintaining a distinction between components and/or features of a specific structure. Use of these terms should not be construed as requiring a specific order or arrangement of the components and/or features being discussed. Also, use of these specific terms in the specification for a specific structure does not require that the same term be used in the claims to refer to the same structure (e.g., a component or feature referred to as the “third” in the specification may correspond to any numerical adjective used for that component or feature in the claims).

Also while the appended figures illustrate features of sole structures 104 and articles of footwear 100 for supporting a wearer’s right foot, those skilled in the art, given benefit of this disclosure, will understand that this technology can be applied to sole structures and articles of footwear for the left foot as well (e.g., as mirror images from the structures illustrated in the appended drawings).

Given the general description of features, aspects, structures, and arrangements according to certain examples of this technology provided above, a more detailed description of specific example foot support systems, sole structures, articles of footwear, and methods in accordance with this technology follows. Where the same reference number appears in multiple figures, the same or similar part is being referenced (including any applicable options or alternatives for that part), and at least some of the overlapping description of that part may be omitted.

At least some aspects of this technology may be well suited for basketball shoes (and/or shoes for other activities) in which fast, hard cutting actions occur at high speeds, applying substantial force to the wearer’s foot and the sole structure of the shoes they wear. Some specific examples of this technology are well suited for basketball played on outdoor courts.

Many outdoor basketball courts are built from coated cement. These surfaces do not deform or store energy as compared to traditional indoor, hardwood basketball court surfaces. Traction on these outdoor court surfaces also may be reduced due to other factors, such as dust and debris accumulation, dampness and/or water accumulation, inconsistencies due to wear on or ablation of the applied coating, etc.

One designing footwear for use on such surfaces may consider providing thicker impact force attenuating elements. But, producing thicker and taller footwear may result in reduced stability (e.g., due to a higher center of mass, greater leverage from force application to the ankle joint, etc.), particularly when sharp turns and/or high speed cutting actions take place. As will be described in more detail below, at least some examples of the present technology use forefoot angled/tilted rigid plate members 260, 660 and/or midsole components of varying hardness and/or lateral side-to-medial side thicknesses to provide lateral stability that permits a taller sole height without compromising cutting performance. More specifically, at least some aspects of this technology, as will be described in more detail below, may provide cushioned-banked support, high surface area contact (e.g., due to the wide forefoot region), and long lasting grip on the contact surface (e.g., less loss of contact area during cutting actions, particularly at the medial forefoot region).

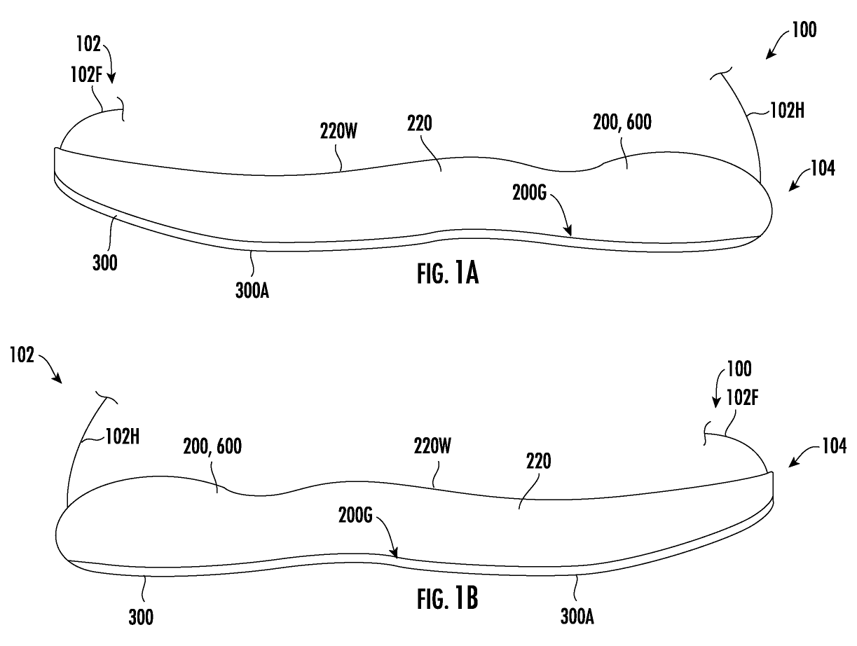

FIGS. 1A and 1B provide a medial side view and a lateral side view, respectively, of a portion of an article of footwear 100 in accordance with at least some examples of this technology. Articles of footwear 100 in accordance with this technology may include a footwear upper 102 and a sole structure 104 engaged with the footwear upper 102. Because aspects of this technology relate primarily to features of the sole structure 104, the upper 102 is shown partially and somewhat schematically in FIGS. 1A and 1B (with a partial upper component 102F shown at the forefoot region and a partial upper component 102H shown at the heel region). The upper 102 may have any type of constructions and/or may be made from one or more component parts, including constructions and/or component parts as are conventionally known and used in the footwear arts.

When made from multiple component parts, the component parts of the upper 102 may be fixed together and/or with other components of the article of footwear 100 structure in any manner (e.g., using adhesives, cements, or other fusing (e.g., welding) techniques; using mechanical fasteners or other hardware; using sewn seams; etc.), including in manners conventionally known and used in the footwear arts. Additionally or alternatively, the upper 102 component(s) may be engaged with the sole structure 104 in any suitable manner (e.g., using adhesives, cements, or other fusing techniques; using mechanical fasteners or other hardware; using sewn seams; etc.), including in manners conventionally known and used in the footwear arts.

Example sole structures 104 in accordance with aspects of this technology now will be described in more detail. As shown in FIGS. 1A and 1B, the sole structure 104 of this illustrated example includes a midsole 200 and an outsole 300. The outsole 300 may have any type of construction and/or may be made from any number of component parts. The outsole 300 may be engaged with the midsole 200 (e.g., with at least a portion of the ground-facing surface 200G of the midsole 200) in any suitable manner (e.g., using adhesives, cements, or other fusing techniques; using mechanical fasteners or other hardware; using sewn seams; etc.), including in manners conventionally known and used in the footwear arts. The outsole 300 may cover any portion(s) and/or proportion of the ground-facing surface 200G of the midsole 200, including up to 100% coverage. Additionally or alternatively, the outsole 300 may include one or more components that are secured (and optionally releasably secured) to another outsole component and/or to the midsole 200.

The ground-contacting surface 300A of the outsole 300 (which may be considered a “bottom foot support surface” as that term is used herein) may have traction elements and/or other traction-enhancing features, such as gaps, grooves, ridges, etc. The traction elements and/or traction-enhancing features may be configured or designed for specific sports and/or specific uses. In accordance with some examples of this technology, the outsole 300 may be configured for—an include traction elements suitable for or optimized for—basketball. As a more specific example, the outsole 300 may be formed from a relatively hard or durable material (e.g., a rubber or thermoplastic polyurethane material) formulated for—and optimized for—basketball typically played on outdoor courts. Such outdoor courts typically are made from asphalt or cement, optionally coated cement, and may be subject to having rain, dust, other debris on its surface. Thus, the outsole 300 may be made from a relatively hard rubber material (or other material) to provide abrasion resistance and avoid material losses due to abrasion.

Midsole 200 and features thereof in accordance with some examples of this technology will be described in more detail below in conjunction with FIGS. 2-7C. FIG. 2 shows a top plan view of midsole 200, and FIGS. 2A-2I provide cross-sectional views taken along lines 2A-2A through 2I-2I in FIG. 2. FIG. 2 further shows the locations of the section line parallel planes 2B-2B through 2I-2I measured forward from the vertical plane VP at the rearmost heel location RH (at P = 0L). More specifically, section line plane 2B-2B is located at about P = 0.87L; plane 2C-2C is located at about P = 0.77L; plane 2D-2D is located at about P = 0.68L; plane 2E-2E is located at about P = 0.58L; plane 2F-2F is located at about P = 0.45L; plane 2G-2G is located at about P = 0.36L; plane 2H-2H is located at about P = 0.22L; and plane 2I-2I is located at about P = 0.13L.

This example midsole 200 includes at least two main midsole components—a first midsole component 220 (e.g., the lower and/or outer midsole component shown in FIGS. 1A-2I) and a second midsole component 240 (e.g., the upper and/or inner midsole component shown in FIGS. 2-2I). This specific example midsole 200 further includes a plate member 260, e.g., located between the first midsole component 220 and the second midsole component 240. The individual components of this example midsole 200 now will be described below in conjunction with FIGS. 2-5E.

The two main midsole components 220 and 240 mentioned above may be made, at least in part, from a foam material. Specific examples of foam materials used for midsole components 220 and 240 will be described in more detail below.

Additionally or alternatively, in some examples of this technology, one or both of midsole component(s) 220 and/or 240 may include other features as well, such as one or more of a fluid-filled bladder component, a mechanical shock absorbing component, etc.

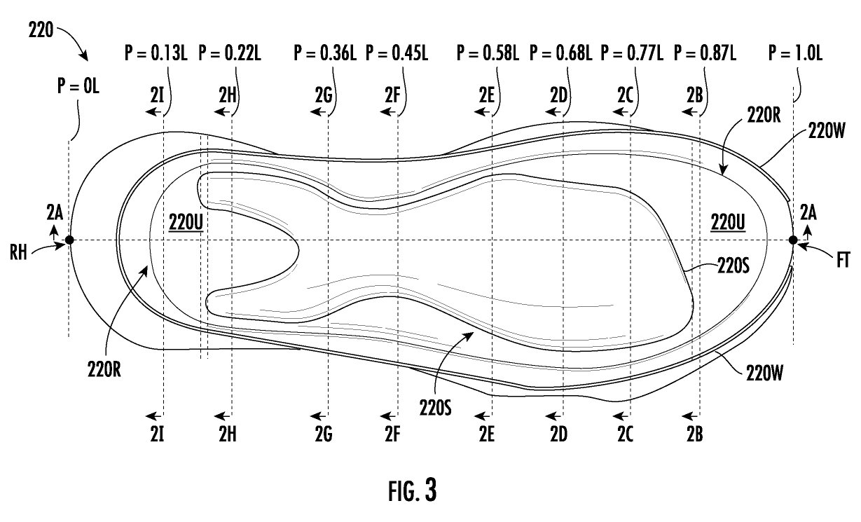

The first midsole component 220 of this example—which also is illustrated in the top plan view of FIG. 3 without the second midsole component 240—includes a ground-facing surface 220G and an upper-facing surface 220U located opposite its ground-facing surface 220G. FIG. 3 further illustrates the locations of the planes of section lines 2A-2A through 2I-2I from FIG. 2 in this example structure (e.g., to show the locations of the section line planes with respect to the complete upper-facing surface 220U of the first midsole component 220). Ground-facing surface 220G also may constitute at least a portion (and optionally all) of the ground-facing surface 200G of the overall midsole component 200.

As shown in FIGS. 2A-3, the upper-facing surface 220U of the first midsole component 220 includes a receptacle 220R defined in it in this illustrated example. While other structures are possible, the receptacle 220R of this example is defined, at least in part, by and/or within raised walls 220W provided around at least some portion(s) (and optionally all) of the perimeter of the first midsole component 220. The receptacle 220R may be sized and shaped to receive, support, conform to, and/or match a shape of the second midsole component 240 described below.

Further, a portion of the upper-facing surface 220U of the first midsole component 220 may have a “receptacle-within-a-receptacle” construction. More specifically, the upper-facing surface 220U of first midsole component 220 may include an additional receptacle 220S defined in it (also called an “inner receptacle” herein). See FIG. 3. This illustrated additional receptacle 220S is located inside an outer perimeter of the upper-facing surface 220U that forms the outer receptacle 220R. A portion of the upper-facing surface 220U of first midsole component 220 within the receptacle 220R—e.g., the additional receptacle 220S—may be sized and shaped to engage, receive, support, conform to, and/or match a shape of the ground-facing surface 260G of a plate member 260, as will be described in more detail below.

FIG. 2 further shows that the first midsole component 220 includes a width dimension W1 extending from the lateral side edge to the medial side edge. The width dimension W1 varies over the longitudinal length of the midsole 200, and the width dimension W1 may be measured horizontally, along a parallel plane as described above (when the sole structure 104 and/or midsole 200 is supported on its ground-facing surface on a horizontal support surface in an unloaded condition). The W1 width also may be measured at the ground-facing surface 220G.

Rather than a recess, in some examples of this technology, at least a portion of element 220S in FIGS. 2A-3 may constitute a raised projection. Such a projection may be sized and shaped to engage, support, conform to, and/or match the shape of the ground-facing surface 260G of a plate member 260.

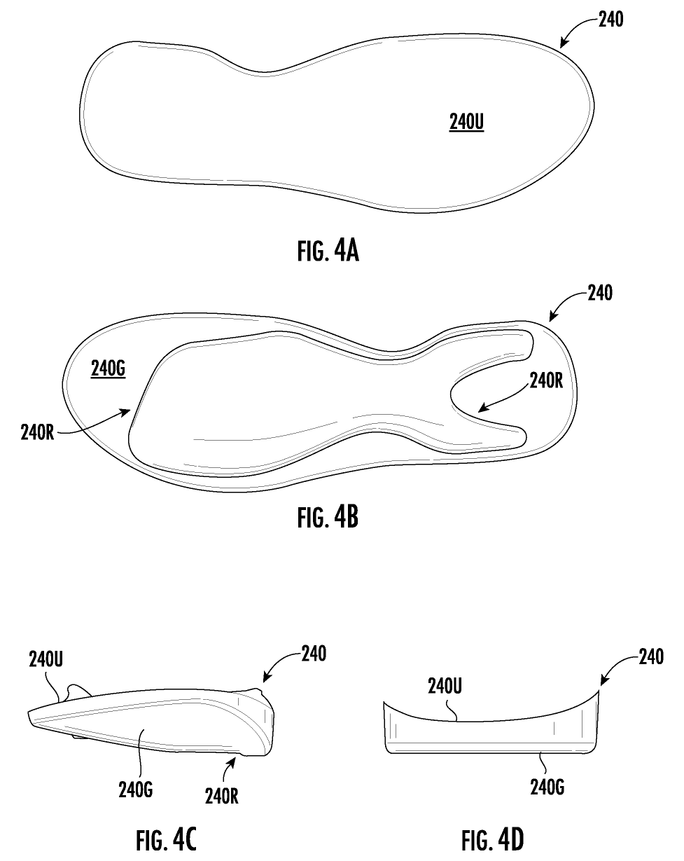

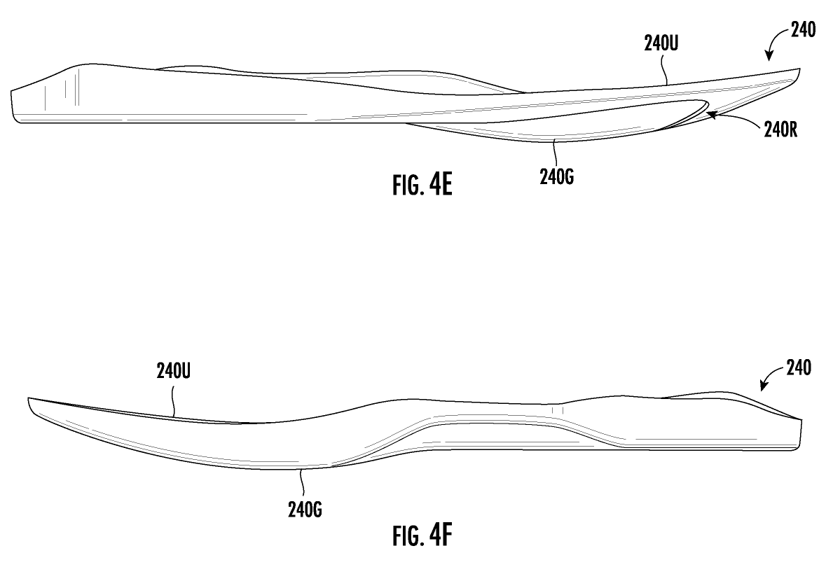

In addition to FIGS. 2-2I, the second midsole component 240 of this illustrated example overall midsole component 200 is illustrated in FIGS. 4A-4F. FIG. 4A provides a top view of the second midsole component 240; FIG. 4B provides a bottom view; FIG. 4C provides a toe end view; FIG. 4D provides a heel end view; FIG. 4E provides a lateral side view; and FIG. 4F provides a medial side view. As shown, this second midsole component 240 includes: (i) a ground-facing surface 240G that faces the upper-facing surface 220U of first midsole component 220 and (ii) an upper-facing surface 240U located opposite the ground-facing surface 240G. The second midsole component 240 of this example is at least partially received in the receptacle 220R (the outer receptacle) of the first midsole component 220, e.g., as shown in FIGS. 2-2I.

FIG. 2 further shows that the second midsole component 240 includes a width dimension W2 extending from its lateral side edge to its medial side edge. The width dimension W2 varies over the longitudinal length of the midsole 200, and the width dimension W2 may be measured horizontally, along a parallel plane as described above (when the sole structure 104 and/or midsole 200 is supported on its ground-facing surface on a horizontal support surface in an unloaded condition).

In at least some examples of this technology, in at least some portion (e.g., at least at some parallel planes) of the forefoot region of the sole structure 104 and/or midsole 200, W2 will be at least 65% of W1, and in some examples, at least 70% or at least 72%. Additionally or alternatively, in at least some portion (e.g., at least at some parallel planes) of the forefoot region of the sole structure 104 and/or midsole 200, W2 will be less than 85% of W1, and in some examples, less than 82% or less than 80%.

In at least some examples, the ground-facing surface 240G of the second midsole component 240 may include a recess 240R (or projection) to engage, accommodate, and/or support at least a portion of plate member 260. See FIGS. 4B and 4C. For example, the recess 240R (or projection) may be sized and shaped so that its surface engages, receives, supports, conforms to, and/or matches a shape of the upper-facing surface 260U of a plate member 260. See FIGS. 2A and 2C-2H.

The recess 240R (or projection) may cooperate with receptacle 220S (or projection) of the first midsole component 220 to engage, support, and/or accommodate opposite sides of the plate member 260. Additionally or alternatively, the surface of component 220S of first midsole component 220 and the surface of component 240R—whether recesses, projections, and/or combinations of recesses and projections—may be sized and shaped to engage, receive, support, conform to, and/or match the shapes of the opposite surfaces of plate member 260. See FIGS. 2A and 2C-2H.

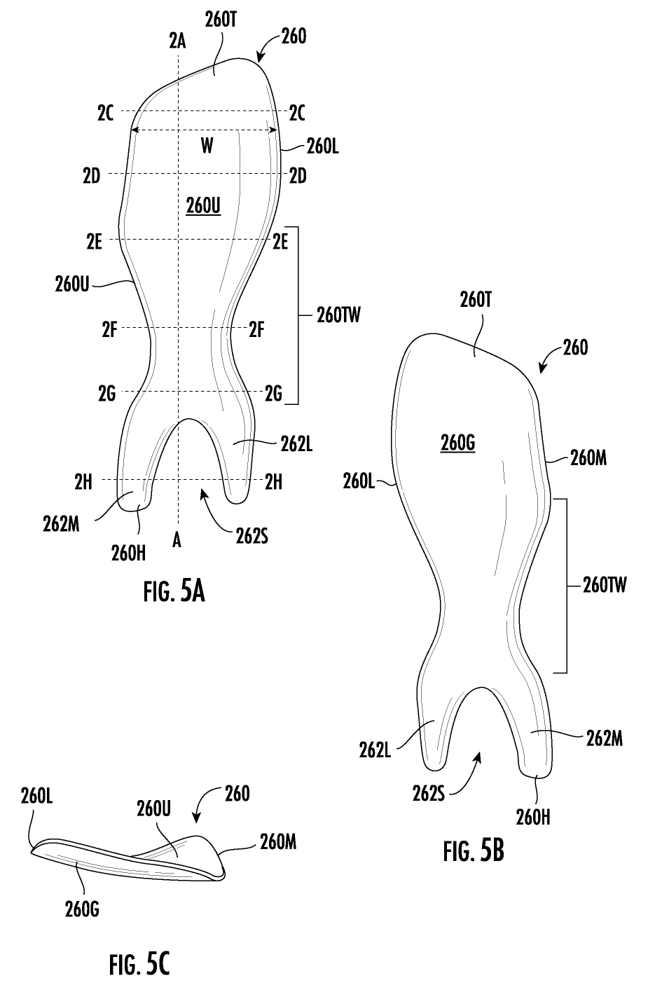

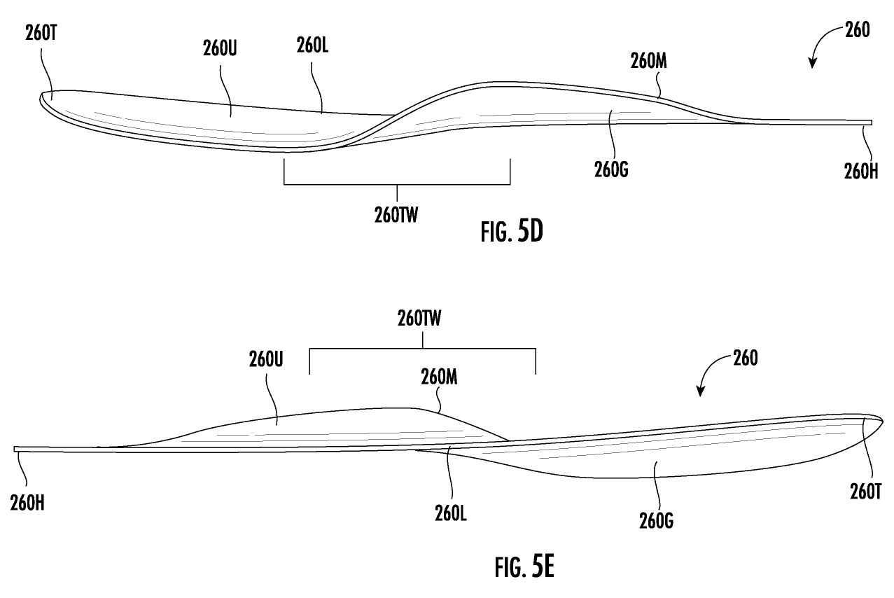

As noted above, the midsole 200 of FIGS. 1A-2I further includes a plate member 260. The plate member 260 additionally is illustrated in FIGS. 5A-5F. FIG. 5A provides a top view of the plate member 260; FIG. 5B provides a bottom view; FIG. 5C provides a toe end view; FIG. 5D provides a lateral side view; and FIG. 5E provides a medial side view. FIG. 5A further illustrates the locations of the planes of section lines 2A-2A and 2C-2C through 2H-2H from FIG. 2 in this example plate member 260 structure (e.g., to show the locations of the section line planes with respect to the plate member 260).

The plate member 260 present in this example is located between the upper-facing 220U surface of the first midsole component 220 and the ground-facing surface 240G of the second midsole component 240. The plate member 260 may be made from a rigid material, such as a carbon fiber plate material. The plate member 260 may deform under applied forces during its intended use and apply a return force to the wearer’s foot as the plate member 260 returns to or toward its original shape as the force is removed or relaxed. The plate member 260 includes an upper-facing surface 260U and an opposite ground-facing surface 260G, and these surfaces 260U and 260G provide a plantar support surface for supporting at least a portion of a plantar surface of a wearer’s foot. The plantar support surface (and the overall plate member 260) has a lateral side edge 260L, a medial side edge 260M, a forward toe edge 260T, and a rearward heel edge 260H.

The plate member 260 may be relatively thin, e.g., compared to thicknesses of the first midsole component 220, the second midsole component 240, and/or the overall midsole 200. As some more specific examples, the plate member 260 may be less than 5 mm thick, and in some examples, less than 3 mm thick, or less than 2 mm thick through at least 50% of the upper-facing surface 260U of the plate member 260 (and in some examples, through at least 60%, at least 75%, at least 80%, at least 90%, at least 95%, or 100% of this surface 260U). Additionally or alternatively, at least a forefoot region of the plate member 260 may have a thickness of less than 5 mm thick, and in some examples, less than 3 mm thick, or less than 2 mm thick. Such thicknesses may be measured as the direct, shortest distance from the upper-facing surface 260U to the ground-facing surface 260G of the plate member 260 at the measurement location. In various examples, the plate member 260 thickness may be substantially constant (e.g., ± 10%), or it may vary over the body of the plate member 260.

In the specific example of this technology illustrated in FIGS. 2A-2I, plate member 260 is at least partially received in the receptacle 220R of the first midsole component 220. More specifically, in this illustrated example, the ground-facing surface 260G of the plate member 260 is received in, supported by, and/or otherwise engages the upper-facing surface 220U of the first midsole component 220 at (e.g., within) receptacle 220S. Additionally or alternatively, plate member 260 is at least partially received in the recess 240R of the second midsole component 240 and/or otherwise engages the second midsole component 240. More specifically, in this illustrated example, the upper-facing surface 260U of the plate member 260 is received in, supported by, and/or otherwise engages the recess 240R (or projection) of the ground-facing surface 240G of the second midsole component 240.

As shown in FIGS. 5A-5E, this example plate member 260 includes a twisted region 260TW in its central region, which corresponds to a midfoot region of the overall sole structure 104 and/or article of footwear 100. This twisted region 260, at least in part, produces a tilt of the plantar support surface (e.g., upper-facing surface 260U) of the plate member 260 at least in the forefoot region of the plate member 260 (and in the forefoot region of the overall sole structure 104 and/or article of footwear 100). Further as evident from FIGS. 2C and 2D, the plantar support surface of the plate member 260 (e.g., its upper-facing surface 260U) located in a forefoot region of the sole structure 104 and/or midsole 200 has a downwardly lateral side-to-medial side tilt across at least 50% of a width dimension W of the plate member 260. In some examples, this downwardly lateral side-to-medial side tilt will extend across at least 60%, at least 75%, at least 80%, at least 90%, or at least 95% of the width dimension W in the forefoot region. The width dimension W may be measured along a parallel plane, e.g., as shown in FIGS. 5A.

At least the forefoot region of the plate member 260 may have a width dimension W that is at least 40% of the width dimension W1 of the first midsole component 220. As some additional examples, width W may be at least 45%, at least 50%, at least 60%, or at least 70% of W1 at a given parallel plane location. Additionally or alternatively, at least at the forefoot region of the plate member 260, the width dimension W may be at least 50% of the width dimension W2 of the second midsole component 240. As some additional examples, width W may be at least 55%, at least 60%, at least 70%, at least 80%, or at least 90% of W2 at a given parallel plane location. The width dimensions W, W1, and/or W2 in this context are measured as the distance across the plane from a lateral outermost edge of the component to the medial outermost edge of the component at that parallel plane location e.g., as shown in FIG. 2D.

More specifically, as illustrated in FIGS. 5A-5E along with 2C-2H, when the sole structure 104 and/or midsole 200 are supported upright with the bottom foot support surface thereof supported on a horizontal support surface in an unloaded condition (e.g., as shown in FIGS. 2C-2H), the plantar support surface (e.g., upper-facing surface 260U) of the plate member 260 is tilted such that the lateral side edge 260L is higher in the sole structure 104 and/or midsole 200 than the medial side edge 260M at least in a portion of a forefoot region of the sole structure 104 and midsole 200. See FIGS. 2C-2E. Additionally, due to the twisted region 260TW, the medial side edge 260M is higher in the sole structure 104 and/or midsole 200 than the lateral side edge 260L, e.g., at least in a portion of a midfoot region (and/or a heel region) of the sole structure 104 and the midsole 200. See FIGS. 2F and 2G. The twisted region 260TW of the plate member 260 in the midfoot region of the sole structure 104 and/or midsole 200 transitions the plantar support surface of the plate member 260 (e.g., its upper-facing surface 260U) from the downward medial side-to-lateral side tilt in the midfoot region to the downward lateral side-to-medial side tilt in the forefoot region. Notably, as used herein, a “downward medial side-to-lateral side tilt” tilts the same general direction as an “upward lateral side-to-medial side tilt” and an “upward medial side-to-lateral side tilt” tilts in the same direction as a “downward lateral side-to-medial side tilt.”

The upper-facing surface 220U of the first midsole component 220 in receptacle 220S of this example has a surface contour to match the twist shape of the ground-facing surface 260G of the plate member 260. Additionally or alternatively, the ground-facing surface 240G of the second midsole component 240 in receptacle 240R of this example has a surface contour to match the twist shape of the upper-facing surface 260U of plate member 260. Thus, the plate member 260 may be “sandwiched” between the upper-facing surface 220U and the ground-facing surface 240G.

Additionally or alternatively, in some specific example structures, at least some portion of receptacle 220S (i.e., the recess thereof)—or optionally all of the receptacle 220S—may be omitted and at least a portion of the upper-facing surface 220U of first midsole component 220 may be formed with a surface contour to match the twist shape of the ground-facing surface 260G of the plate member 260 (e.g., without any or all of that surface contour being located in a recessed receptacle). In fact, at least some of that surface contour of upper-facing surface 220U may project outward from a base level of upper-facing surface 220U (e.g., to form a projection). Still additionally or alternatively, in some specific example structures, at least some portion of receptacle 240R (i.e., the recess thereof)—or optionally all of the receptacle 240R—may be omitted and at least a portion of the ground-facing surface 240G of second midsole component 240G may be formed with a surface contour to match the twist shape of the upper-facing surface 260U of the plate member 260 (e.g., without any or all of that surface contour being located in a recessed receptacle). In fact, at least some of that surface contour of ground-facing surface 240G may project outward from a base level of ground-facing surface 240G (e.g., to form a projection). Combinations of receptacles (e.g., 220S and/or 240R) and projecting surfaces may be provided on the midsole components 220 and 240 to provide support for the plate member 260. Thus, a variety of different structural arrangements may be provided for “sandwiching” the plate member 260 between the facing surfaces of the first midsole component 220 and the second midsole component 240 in various specific examples of this technology.

As noted above, the above tilt features are observed when the sole structure 104 and/or midsole 200 are supported upright with the bottom foot support surface thereof supported on a horizontal support surface in an unloaded condition (e.g., as shown in FIGS. 2C-2H). All relative positioning features described in this specification and all positions with respect to the longitudinal length features are made with the sole structure 104 and/or the midsole 200 oriented in this manner.

FIG. 2C illustrates some further potential features of the tilt when the sole structure 104 or midsole 200 is supported upright with the bottom foot support surface thereof supported on a horizontal support surface in an unloaded condition. As described above, the sole structure 104 (or midsole 200) defines a longitudinal distance L as a shortest direct distance between parallel vertical planes contacting a rearmost heel RH location of the sole structure 104 (or midsole 200) and a forwardmost toe FT location of the sole structure 104 (or midsole 200). At some locations in the forefoot region of the sole structure 104 (or midsole 200), such as at parallel plane at P = 0.77L shown in FIG. 2C, at parallel plane at P = 0.68L shown in FIG. 2D, and/or at locations between P = 0.77L and P = 0.68L: a first angle α1 of at least 5 degrees is defined between: (i) a first line segment 264A extending along the parallel plane from the medial side edge 260M of the plantar support surface of the plate member 260 (e.g., its upper-facing surface 260U) to the lateral side edge 260L of the plantar support surface (e.g., its upper-facing surface 260U) and (ii) a horizontal line segment 264B extending along the parallel plane through a junction of the first line segment 264A and the medial side edge 260M. In some examples, α1 may be at least 6 degrees, at least 8 degrees, at least 10 degrees, between 5 degrees and 18 degrees, or between 7 degrees and 15 degrees.

As noted above, the tilt angle α1 may be provided in the forefoot region of the sole structure 104 and/or midsole 200. In at least some examples of this technology, the parallel plane where the α1 measurements are made may be located in the forefoot region of the sole structure 104 and/or midsole 200 and at or rearward of a parallel plane located at 0.8L measured forward from the RH vertical plane, where L is the longitudinal distance (i.e., the distance between the RH vertical plane and the FT vertical plane).

But, as noted above, the midfoot region of a sole structure 104 and/or midsole 200 may have different plate member 260 tilt properties (e.g., due to the “twist” feature of plate member 260). This is illustrated, for example, in a comparison of FIGS. 2C and 2D with 2F and 2G. More specifically, at some locations in the midfoot region of the sole structure 104 (or midsole 200), such as at the parallel plane at P = 0.45L shown in FIG. 2F, at the parallel plane at P = 0.36L shown in FIG. 2G, and/or at locations between P = 0.45L and P = 0.36L: a second angle α2 of at least 5 degrees is defined between: (i) a first line segment 266A extending along the first plane from the medial side edge 260M of the plantar support surface of the plate member 260 (e.g., its upper-facing surface 260U) to the lateral side edge 260L of the plantar support surface (e.g., its upper-facing surface 260U) and (ii) a horizontal line segment 266B extending along the parallel plane through a junction of the first line segment 266A and the lateral side edge 260L. In some examples, α2 may be at least 6 degrees, at least 8 degrees, at least 10 degrees, between 5 degrees and 18 degrees, or between 7 degrees and 15 degrees.

As noted above, the tilt angle α2 may be provided in the midfoot region of the sole structure 104 and/or midsole 200. In at least some examples of this technology, the parallel plane where the α2 measurements are made may be located in the midfoot region of the sole structure 104 and/or midsole 200 and at or rearward of a parallel plane located at 0.5L measured forward from the RH vertical plane, where L is the longitudinal distance (i.e., the distance between the RH vertical plane and the FT vertical plane).

FIG. 2C illustrates still additional potential features of plate member 260, midsole 200, and/or sole structure 104 in accordance with at least some examples of this technology. When the sole structure 104 and/or midsole 200 is supported upright with the bottom foot support surface thereof supported on a horizontal support surface in an unloaded condition, the sole structure 104 and/or midsole 200 define a longitudinal distance as a shortest direct distance between parallel vertical planes contacting a rearmost heel RH location of the sole structure 104 and/or midsole 200 and a forwardmost toe FT location of the sole structure 104 and/or midsole 200, wherein at a first plane parallel to the parallel RH and FT vertical planes, at a lateral edge 260L of the plate member 260, the sole structure 104 and/or midsole 200 defines: (a) a total vertical thickness T_{T} measured from the ground-facing surface 220U of the first midsole component 220 to the upper-facing surface 240U of the second midsole component 240, (b) a first midsole component vertical thickness T₁ measured from the ground-facing surface 220G of the first midsole component 220 to the upper-facing surface 220U of the first midsole component 220, and (c) a second midsole component vertical thickness T₂ measured from the ground-facing surface 240G of the second midsole component 240 to the upper-facing surface 240U of the second midsole component 240. In at least some examples, at this parallel plane, T₁ will be at least 65% of T_{T}, and T₂ will be less than 35% of T_{T}. In some examples, at this parallel plane, T₁ will be at least 50% of T_{T}, T₁will be at least 70% of T_{T}, and/or T₁ will be at least 75% of T_{T}. Additionally or alternatively, in at least some examples, at this parallel plane, T₂ will be less than 50% of T_{T}, T₂ will be less than 30% of T_{T}, and/or T₂will be less than 25% of T_{T}.

Additionally or alternatively, as also shown in FIG. 2C, at this forefoot parallel plane and at the medial edge 260M of the plate member 260, T₁ will be less than 40% of T_{T} and T₂ will be at least 55% of T_{T}. In some examples, at this parallel plane, T₁ will be less than 35% of T_{T}, and/or T₁ will be less than 30% of T_{T}. Additionally or alternatively, in at least some examples, at this plane, T₂ will be at least 60% of T_{T}, and/or T₂ will be at least 65% of T_{T}. Thus, at least at some parallel planes in the forefoot region, first midsole component 220 is thicker at the lateral side than at the medial side, and second midsole component 240 is thicker at the medial side than at the lateral side.

Additionally or alternatively, as shown in the example of FIGS. 2C and 2D (but may be present in other midsole structures), at least at some parallel planes in the forefoot region: (i) the first midsole component 220 will make up a larger proportion of the total midsole 200 thickness and/or overall sole thickness 104 at the lateral side than it does at the medial side; and/or (ii) the second midsole component 240 will make up a larger proportion of the total midsole 200 thickness and/or overall sole thickness 104 at the medial side than it does at the lateral medial side.

FIGS. 2H, 5A, and 5B further illustrate that a rearward end of the plate member 260 splits to include a medial arm 262M and a lateral arm 262L. The rearward heel edge 260H of the plate member 260 includes a forwardly extending space 262S that separates the medial arm 262M and lateral arm 262L. Also, as shown in FIG. 2H, in this illustrated example, when the sole structure 104 and/or midsole 200 is supported upright with the bottom foot support surface thereof supported on a horizontal support surface in an unloaded condition, the medial arm 262M and the lateral arm 262L of the plate member 260 are at substantially the same height within at least a portion of a heel region of the sole structure 104 and/or midsole 200. The term “substantially the same height” as used herein in this context means that (a) the dimension upward from the horizontal support surface to the upper-facing surface 260U of the plate member 260 at the medial arm 262M (DM in FIG. 2H) and (b) the dimension upward from the horizontal support surface to the upper-facing surface 260U of the plate member 260 at the lateral arm 262L (DL in FIG. 2H) are the same and/or within 5 mm from one another. In some examples, DM and DL will be within 3 mm or within 2 mm of one another.

Additionally or alternatively, a rearmost edge and/or rearmost point along rearward edge 260H of the medial arm 262M and a rearmost edge and/or rearmost point along rearward edge 260H of the lateral arm 262L of the plate member 260 may be at substantially the same height (e.g., even if these rearmost edges or points do not lie on the same parallel plane.

FIG. 2E illustrates the midsole 200 at a parallel plane location in the midfoot region. As shown, in at least a portion of the midfoot region, the plate member 260 (and thus the supporting surfaces of the first midsole component 220 and the second midsole component 240) has a somewhat “U-shaped” configuration, e.g., with a slope change point 268 or the horizontal tangent of the plate member 260 located between the lateral edge 260L and the medial edge 260M. This slope change point 268 or tangent point is located in a central region of the midsole 200 with respect to the side-to-side direction.

The plate member 260 may span less than the complete longitudinal length L of the sole structure 104 and/or midsole 200. In some examples of this technology, an entirety of the plate member 260 may be located forward of a parallel heel plane located at 0.1L (and in some examples, forward of a parallel plane located at 0.15L, forward of a parallel plane located at 0.18L, and/or forward of a parallel plane located at 0.2L). Additionally or alternatively, in some examples of this technology, an entirety of the plate member 260 may be located rearward of a parallel forefoot plane located at 0.95L (and in some examples, rearward of a parallel plane located at 0.92L and/or rearward of a parallel plane located at 0.9L).

At least some portion (and optionally all) of the plate member 260 may be located between the first midsole component 220 and the second midsole component 240. For example, at least some portion (and optionally all) of the plate member 260 may be located between the upper-facing surface 220U of the first midsole component 220 and the ground-facing surface 240G of the second midsole component 240. Additionally or alternatively, the plate member 260 may be fixed with respect to at least one of the first midsole component 220 and the second midsole component 240, e.g., directly fixed to foam material of the first midsole component 220 at the upper-facing surface 220U thereof and/or directly fixed to foam material of the second midsole component 240 at the ground-facing surface 240G thereof. This plate member 260 may be fixed to either or both of the midsole components 220, 240 by adhesives, by mechanical fasteners, by friction fit, by retaining elements, and/or in any other suitable technique.

As noted above, first midsole component 220 and second midsole component 240 may be made, at least in part, from foam materials. The foam materials of these two components 220, 240, however, may be different (e.g., have different properties). Specific examples of foam materials used for midsole components 220 and 240 in some examples of this technology will be described in more detail below.

The first midsole component 220 (e.g., its foam material) may be harder and/or more dense than the second midsole component 240 (e.g., its foam material), e.g., at least at the forefoot region of the sole structure 104 and/or midsole component 200. As some more specific examples, the first midsole component 220 (e.g., the foam material thereof) may have a first hardness and the second midsole component 240 (e.g., the foam material thereof) may have a second hardness that is less than the first hardness. In some more specific examples, the first hardness of the first midsole component 220 may be at least 4 Asker C durometer hardness points greater than the second hardness of the second midsole component 240, at least at a forefoot support region of the sole structure 104 and/or midsole component 200. In other examples, the first hardness may be at least 5, at least 6, or even at least 7 Asker C durometer hardness points greater than the second hardness.

As some additional examples, the foam material of the first midsole component 220 may have a hardness of at least 40 Asker C, and in some examples, at least 42 Asker C, or at least 44 Asker C. Additionally or alternatively, the foam material of the second midsole component 240 may have a hardness of less than 42 Asker C, and in some examples, less than 40 Asker C or less than 38 Asker C.

With respect to relative density features, as some more specific examples, the first midsole component 220 (e.g., the foam material thereof) may have a first density or specific gravity and the second midsole component 240 (e.g., the foam material thereof) may have a second density or specific gravity that is less than the first density or specific gravity. In some more specific examples, the first specific gravity of the first midsole component 220 may be at least 0.15, and in some examples, at least 0.16, at least 0.175, or at least 0.19. Additionally or alternatively, in some more specific examples, the second specific gravity of the second midsole component 240 may be less than 0.15, and in some examples, less than 0.14, or less than 0.13. Additionally or alternatively, in some examples, the first specific gravity may be at least 0.03 higher than the second specific gravity (and, in some examples, at least 0.05 or at least 0.06 higher). As some additional examples, at least at a forefoot region of the sole structure 104 and/or midsole 200, the foam material of the first midsole component 220 may have a specific gravity in a range of 0.175 to 0.25, and/or the foam material of the second midsole component 240 may have a specific gravity of less than 0.175 and/or in a range from 0.1 to 0.15. All specific gravity information contained herein is with respect to water at 4°C as the reference material.

The two midsole components 220, 240 may differ in other properties as well. With respect to secant stiffness, the first midsole component 220 (e.g., its foam material) may have a higher secant stiffness than that of the second midsole component 240 (e.g., its foam material). As more specific examples, the first midsole component 220 (e.g., the foam material thereof) may have a first secant stiffness of at least 205 N/mm, and in some examples, at least 215 N/mm or at least 225 N/mm. Additionally or alternatively, the second midsole component 240 (e.g., the foam material thereof) may have a second secant stiffness of less than 205 N/mm, and in some examples, less than 195 N/mm or less than 190 N/mm. Additionally or alternatively, in some examples, the first secant stiffness may be at least 25 N/mm higher than the second secant stiffness, and in some examples, at least 30 N/mm higher, at least 35 N/mm higher, or at least 40 N/mm higher. As some additional or alternative specific examples, at least at a forefoot region of the sole structure 104 and/or midsole 200, the first foam member of the first midsole component 220 may have a secant stiffness of 230 N/mm ± 10% (or ± 5%) and/or the second foam member of the second midsole component 240 may have a secant stiffness of 185 N/mm ± 10% (or ± 5%).

Additionally or alternatively, with respect to energy return properties, the second midsole component 240 (e.g., its foam material) may have a higher energy return than that of the first midsole component 220 (e.g., its foam material). As more specific examples, the second midsole component 240 (e.g., the foam material thereof) may have an energy return of at least 6.5 J, and in some examples, at least 7 J, or at least 7.5 J. Additionally or alternatively, the first midsole component 220 (e.g., the foam material thereof) may have an energy return of less than 6.5 J, and in some examples, less than 6.2 J or less than 6 J. Additionally or alternatively, in some examples, the second midsole component 240’s energy return may be at least 0.5 J greater than that of the first midsole component 220, and in some examples, at least 0.75 J, at least 1 J, or at least 1.5 J higher. As some additional or alternative examples, at least at a forefoot region of the sole structure 104 and/or midsole 200, the foam material of the first midsole component 220 may have an energy return in a range of 5 to 6.5 Joules, and/or the foam material of the second midsole component 240 may have an energy return in a range of 6.5 to 8.2 Joules.

Additionally or alternatively, with respect to energy efficiency properties, the second midsole component 240 (e.g., its foam material) may have a higher energy efficiency than that of the first midsole component 220 (e.g., its foam material). As more specific examples, the second midsole component 240 (e.g., the foam material thereof) may have an energy efficiency of at least 89%, and the first midsole component 220 (e.g., the foam material thereof) may have an energy efficiency of less than 89% (and in some examples, less than 88%). Additionally or alternatively, in some examples, the second midsole component 240’s energy efficiency may be at least 1 percentage point higher than the first midsole component 220’s energy return, and in some examples, at least 2 percentage points higher.

Foam materials for first midsole component 220 and the second midsole component 240 may be of the types used in various footwear products, e.g., available from NIKE, Inc., of Beaverton, Oregon. In some examples: (a) the foam material of the first midsole component 220 may be a combination of a thermoplastic elastomer (TPE) and ethylene vinyl acetate (EVA) materials; and/or (b) the foam material of the second midsole component 240 may be polyether-block-amide block copolymer thermoplastic elastomer (TPE) that includes polyamide blocks (rigid) and ether blocks (elastomeric).

FIGS. 2B-2E further show that when the sole structure 104 and/or midsole 200 is/are supported upright with the bottom foot support surface thereof supported on the horizontal support surface in the unloaded condition, the ground-facing surface 220G of the first midsole component 220 may be substantially horizontal at parallel planes that span across the sole structure 104 and/or midsole 200 from the lateral side edge to the medial side edge. The ground-contacting surface 300A of an underlying outsole component 300 (if any) may have similar general shape properties, e.g., at least in the forefoot region. In this manner, a large surface area is provided at least at the forefoot region for engaging the contact surface, e.g., when making a turn or cutting action.

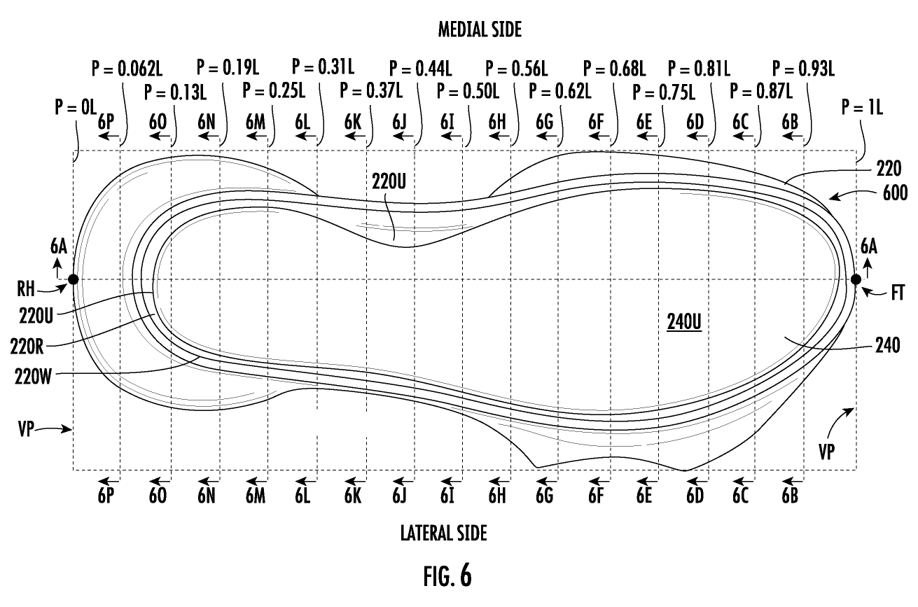

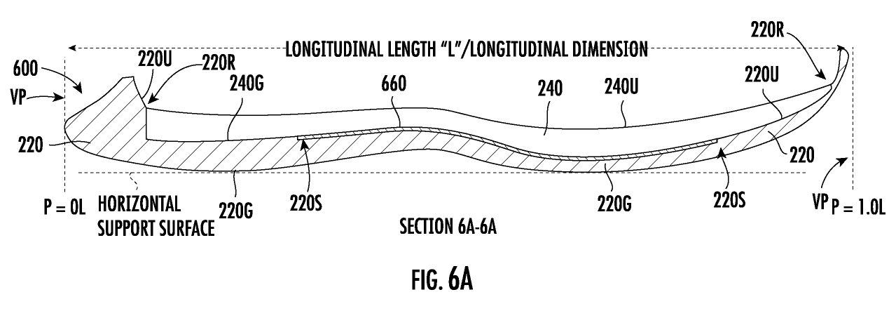

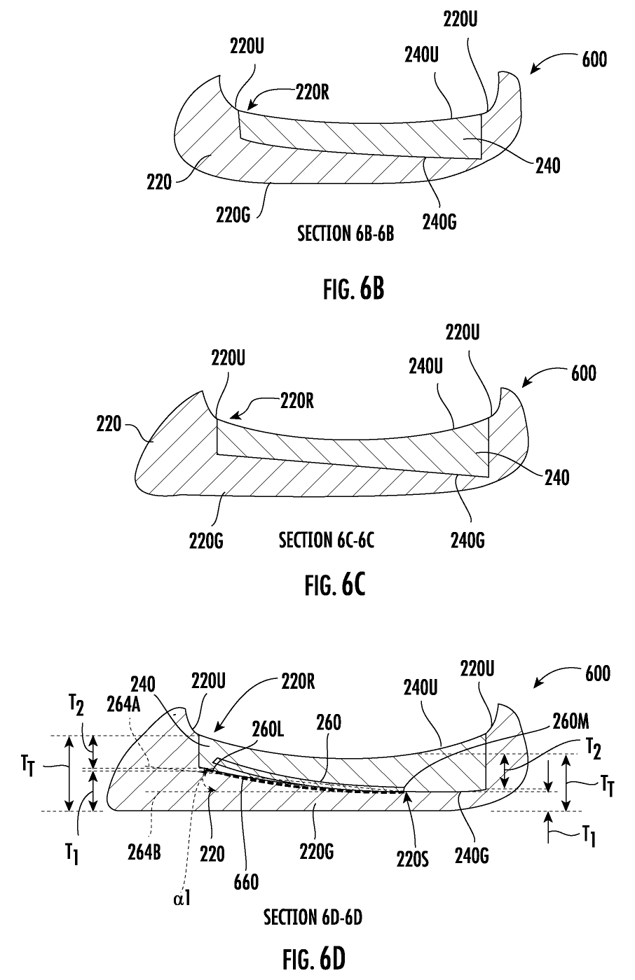

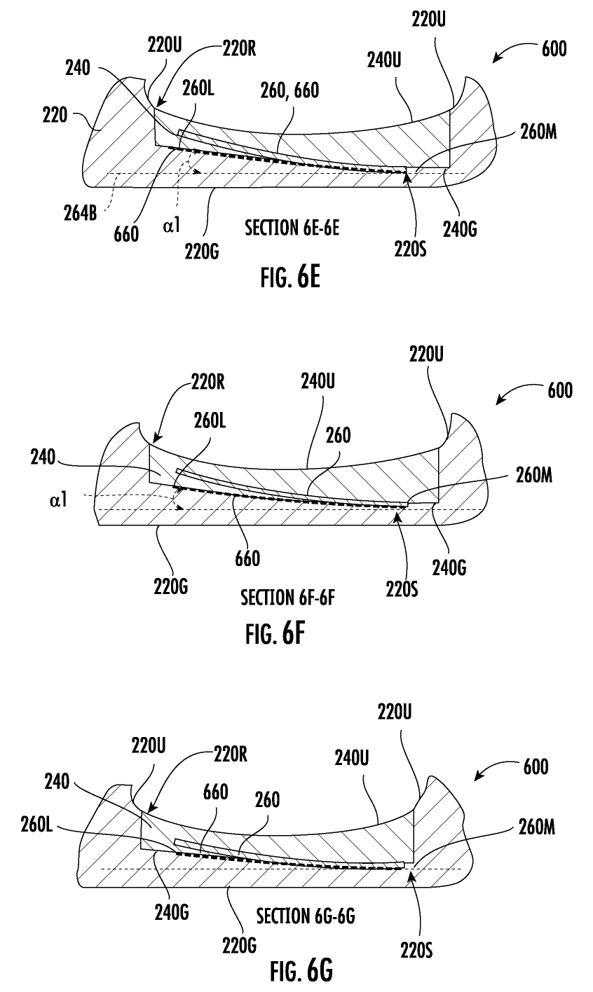

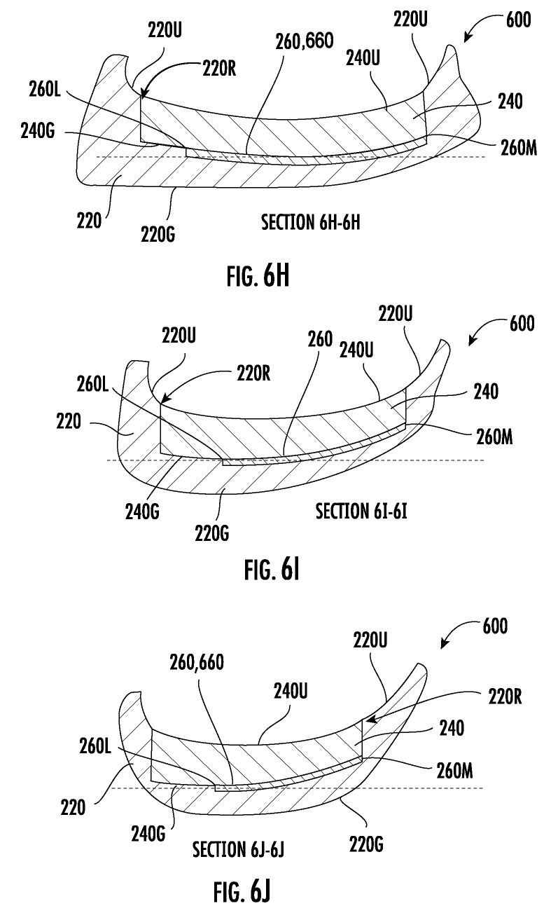

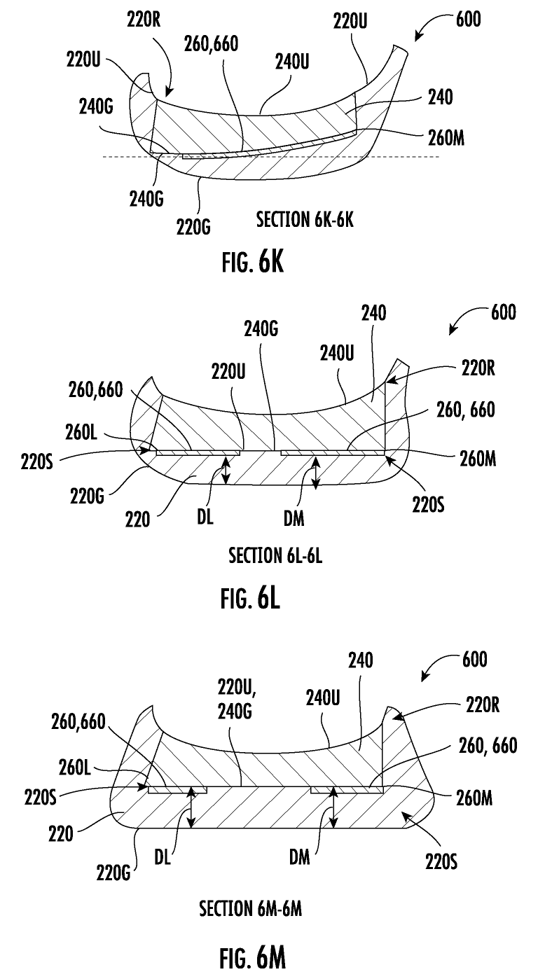

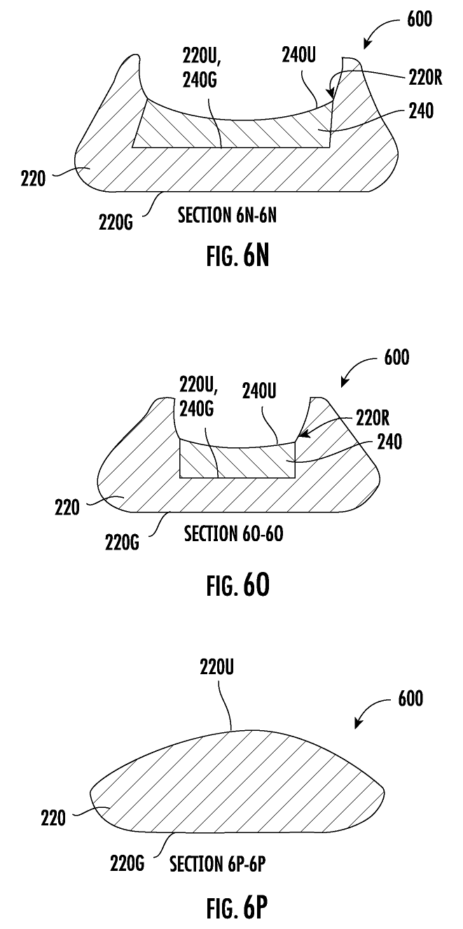

FIGS. 6-6P illustrate another example midsole 600 and features thereof in accordance with some examples of this technology. The midsole 600 of FIGS. 6-6P is similar to the midsole 200 of FIGS. 2-2I, with the same general component parts, e.g., first midsole component 220, second midsole component 240, and a rigid plate member 660 (each of which may be made from the same materials as those described above for first midsole component 220, second midsole component 240, and a rigid plate member 260). Thus, where the same reference number is used in FIGS. 6-6P as those used in FIGS. 2-2I, the same or similar parts are being referenced, including any features, options, and/or alternatives for those parts, and much of the overlapping description has been omitted. The discussion below will focus on differences between the midsole 600 of FIGS. 6-6P as compared to the midsole 200 of FIGS. 2-2I.

FIG. 6 shows a top plan view of midsole 600, and FIGS. 6A-6P provide cross-sectional views taken along lines 6A-6A through 6P-6P in FIG. 6. FIG. 6 further shows the locations of the section line planes 6B-6B through 6P-6P measured forward from a vertical plane VP at the rearmost heel location RH (at P = 0L). More specifically, section line plane 6B-6B is located at about P = 0.93L; plane 6C-6C is located at about P = 0.87L; plane 6D-6D is located at about P = 0.81L; plane 6E-6E is located at about P = 0.75L; plane 6F-6F is located at about P = 0.68L; plane 6G-6G is located at about P = 0.62L; plane 6H-6H is located at about P = 0.56L; plane 6I-6I is located at about P = 0.5L; plane 6J-6J is located at about P = 0.44L; plane 6K-6K is located at about P = 0.37L; plane 6L-6L is located at about P = 0.31L; plane 6M-6M is located at about P = 0.25L; plane 6N-6N is located at about P = 0.19L; plane 6O-6O is located at about P = 0.13L; and plane 6P-6P is located at about P = 0.062L.

One difference between the rigid plate 260 of FIGS. 2-2I and the rigid plate 660 of FIGS. 6-6P is the extent of the tilt, particularly in the forefoot area. In FIGS. 6D-6I, the general plate member 260 position from the example of FIGS. 2-2J is shown as a solid line and the general plate member 660 position from the present example of FIGS. 6-6P is shown as a thick broken line. As evident at least from FIGS. 6D to 6H, the plate member 260 of FIGS. 2-2J has a somewhat greater downward lateral side-to-medial side forefoot tilt as compared to the plate member 660 of FIGS. 6-6P. In other words, the angle α1 for the example plate member 260 of FIGS. 2-2I may be somewhat larger than the angle α1 for the example plate member 660 of FIGS. 6-6P at generally corresponding parallel plane locations in the forefoot region of the sole member 104 and/or midsoles 200, 600. The angle α1 (and/or α2) for the sole structure 104 and/or midsole 200 of FIGS. 6-6P still may be within the ranges described above in conjunction with FIGS. 2-2J.

Additionally or alternatively, the values for T₁, T₂, and T_{T} in the example of FIGS. 2-2I may differ somewhat as compared to those corresponding values for the example of FIGS. 6-6P. For the example of FIGS. 6-6P, at the lateral side edge 260L: (i) the absolute value of T₁ and the T₁/T_{T} percentages may be lower, and (ii) the absolute value of T₂ and the T₂/T_{T} percentages may be higher as compared to the corresponding values for the example of FIGS. 2-2I. But the values of T₁, T₂, the T₁/T_{T}%, and/or T₂/T_{T}% for the sole structure 104 and/or midsole 200 of FIGS. 6-6P may be within the ranges described above in conjunction with FIGS. 2-2J.

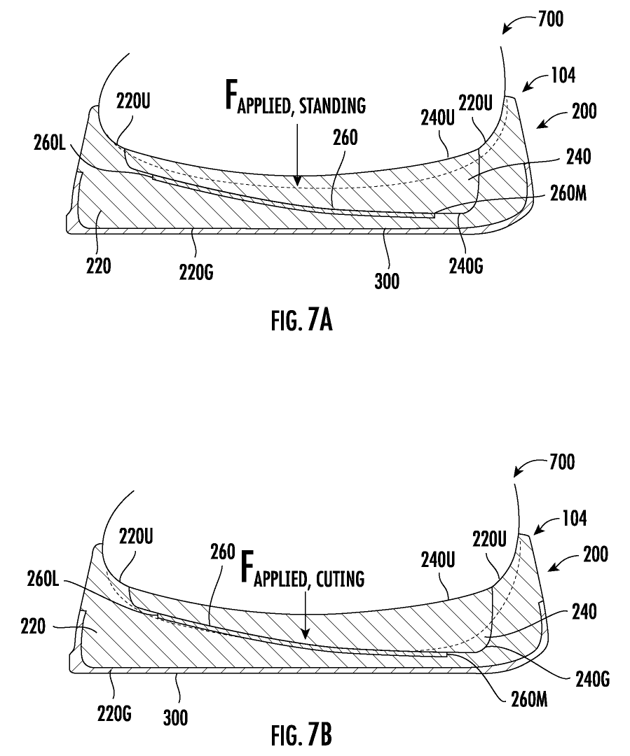

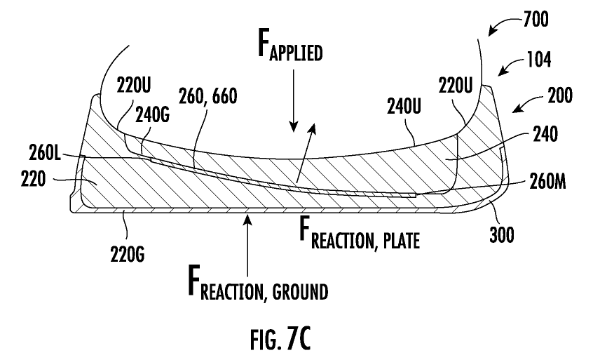

Additional aspects of this technology now will be described in conjunction with FIGS. 7A-7C. The views of FIGS. 7A-7C are similar to the views of FIG. 2C, but with the outsole component 300 also included and with a portion of a wearer’s foot 700 illustrated.

As noted above, aspects of this technology may be well suited for basketball shoes and/or other shoes in which fast, hard cutting actions occur at high speeds, applying substantial force to the wearer’s foot 700 and the sole structure 104 of the shoes they wear.

FIG. 7A shows the sole structure 104 with a stationary standing force F_{Applied, standing}applied to it by a wearer’s foot 700. As shown, with a 400N force applied (e.g., ½ a typical user’s body weight), the second midsole component 240 (the foam material thereof) is deformed relatively evenly (shown by the broken line in FIG. 7A).

When a wearer makes a cutting movement (e.g., a rapid and/or sharp turn, such as when playing basketball), a larger force is applied to the sole structure 104 and the wearer’s foot 700 compresses the foam materials of the midsole components 220, 240. In some examples, the F_{Applied, cutting} may be 3 times the person’s body weight (e.g., 2400N) or even more on that one foot (e.g., due to the fact that the wearer may be on only one foot 700 and has applied all force of the body weight and the motion direction change to that one foot 700). This is shown in FIG. 7B. In the examples of this technology described above, at the forefoot region, the medial side of the footbed will deform more than the lateral side (e.g., up to 20% more or greater), e.g., due to the thicker layer (T2) of the foam material of the second midsole component 240 on the medial side.

In conventional sole structures, applied forces will create an equal and opposite reaction force (e.g., applied vertically upward against the wearer’s foot 700). In sole structures 104 in accordance with aspects of the present technology, however, due to the tilted plate 260, 660, the applied force will create a reaction force at the plate member 260 that is generally perpendicular to the plate member 260 (see F_{Reaction, Plate} in FIG. 7C). This F_{Reaction, Plate} better aligns the reaction force to the desired direction of movement, thereby improving (and potentially optimizing) the force transfer for making the cut. The reaction force between the sole structure 104 and the contact surface is shifted laterally, creating positive movement about the center of the shoe.

The above effect further is enhanced by the softer and thicker foam material of the second midsole component 240 at the medial forefoot region (the foam material located above the plate member 260, 660). That foam material of the second midsole component 240 compresses at the medial side, thereby creating a cambered surface and angling the applied force to create a reaction force more optimized for the cutting action. The thicker and softer foam material of the second midsole component 240 at the medial side provides a greater volume of the relatively soft foam to create greater medial side compression and to support creation of the F_{Reaction Plate} force described above.

Features of the midsole component 200 (e.g., one or more of the different hardness foam materials, other foam material property differences, the titled forefoot plate, the twisted plate, and/or the different foam thickness, etc.) as described herein help keep the medial side of the foot support surface of the sole structure 104 at the forefoot region in contact with the contact surface for a longer period during the cutting action (e.g., help “pin” the medial forefoot of the sole structure 104 to the ground).

Additionally or alternatively, in at least some examples of this technology, the outsole 300 will create a large forefoot contact area for contacting the ground. The rigid plate member 260 (stiff from the medial to lateral sides) and the softer second midsole component 240 help “pin” the medial forefoot of the sole member 104 to the ground or other contact surface, thereby helping maintain a larger forefoot contact area. Less ground contact loss and more distributed traction forces are experienced. Further, the first midsole component 220 located adjacent the outsole component 300 helps increase surface conformity.

For avoidance of doubt, this invention includes within its scope at least the information described in the following numbered “Clauses:”

Clause 1. A sole structure for an article of footwear that includes a bottom foot support surface, the sole structure comprising: (A) a first midsole component including a first ground-facing surface and a first upper-facing surface located opposite the first ground-facing surface, wherein the first upper-facing surface defines a receptacle; (B) a second midsole component at least partially received in the receptacle, the second midsole component including a second ground-facing surface that faces the first upper-facing surface and a second upper-facing surface located opposite the second ground-facing surface; and (C) a plate member at least partially received in the receptacle and located between the first upper-facing surface and the second ground-facing surface, wherein the plate member includes a plantar support surface having a lateral side edge and a medial side edge, wherein when the sole structure is supported upright with the bottom foot support surface thereof supported on a horizontal support surface in an unloaded condition, the plantar support surface of the plate member is tilted such that the lateral side edge is higher in the sole structure than the medial side edge at least in a portion of a forefoot region of the sole structure.

Clause 2. The sole structure according to Clause 1, wherein the plate member includes a twisted region in a midfoot region of the sole structure to produce tilt of the plantar support surface at least in the forefoot region.

Clause 3. The sole structure according to Clause 1, wherein when the sole structure is supported upright with the bottom foot support surface thereof supported on the horizontal support surface in the unloaded condition, the plantar support surface of the plate member is tilted such that the medial side edge is higher in the sole structure than the lateral side edge in at least a portion of a midfoot region of the sole structure.

Clause 4. The sole structure according to Clause 3, wherein the plate member includes a twisted region in the midfoot region of the sole structure to transition from the tilt of the plantar support surface in the midfoot region to the tilt of the plantar support surface in the forefoot region.

Clause 5. The sole structure according to any one of Clauses 1 to 4, wherein a rearward end of the plate member includes a medial arm, a lateral arm, and a forwardly extending space separating the medial arm and the lateral arm.

Clause 6. The sole structure according to Clause 5, wherein when the sole structure is supported upright with the bottom foot support surface thereof supported on the horizontal support surface in the unloaded condition, the medial arm and the lateral arm of the plate member are at substantially the same height within at least a portion of a heel region of the sole structure.

Clause 7. The sole structure according to Clause 5, wherein when the sole structure is supported upright with the bottom foot support surface thereof supported on the horizontal support surface in the unloaded condition, a rearmost edge of the medial arm and a rearmost edge of the lateral arm are at substantially the same height.

Clause 8. The sole structure according to any one of Clauses 1 to 7, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, and wherein at a first plane parallel to the parallel vertical planes located in the forefoot region of the sole structure: a first angle of at least 5 degrees is defined between: (i) a first line segment extending along the first plane from the medial side edge of the plantar support surface to the lateral side edge of the plantar support surface and (ii) a horizontal line segment extending along the first plane through a junction of the first line segment and the medial side edge.

Clause 9. The sole structure according to Clause 8, wherein the first angle is at least 6 degrees.

Clause 10. The sole structure according to Clause 8, wherein the first angle is at least 10 degrees.

Clause 11. The sole structure according to any one of Clauses 8 to 10, wherein the first plane in the forefoot region is located rearward of a second plane parallel to the parallel vertical planes located at 0.8L measured forward from the vertical plane at the rearmost heel location, where L is the longitudinal distance.

Clause 12. The sole structure according to any one of Clauses 1 to 11, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, and wherein at a first plane parallel to the parallel vertical planes located in a midfoot region of the sole structure: a second angle of at least 5 degrees is defined between: (i) a first line segment extending along the first plane in the midfoot region from the medial side edge of the plantar support surface to the lateral side edge of the plantar support surface and (ii) a horizontal line segment extending along the first plane in the midfoot region and through a junction of the first line segment and the lateral side edge.

Clause 13. The sole structure according to Clause 12, wherein the second angle is at least 6 degrees.

Clause 14. The sole structure according to Clause 12, wherein the second angle is at least 10 degrees.

Clause 15. The sole structure according to any one of Clauses 12 to 14, wherein the first plane in the midfoot region of the sole structure is located rearward of a second plane parallel to the parallel vertical planes located at 0.5L measured forward from the vertical plane at the rearmost heel location, where L is the longitudinal distance.

Clause 16. The sole structure according to any one of Clauses 1 to 15, wherein when the sole structure is supported upright with the bottom foot support surface thereof supported on the horizontal support surface in the unloaded condition, the sole structure defines a longitudinal distance L as a shortest direct distance between parallel vertical planes contacting a rearmost heel location of the sole structure and a forwardmost toe location of the sole structure, and wherein an entirety of the plate member is located forward of a first heel plane parallel to the parallel vertical planes and located at 0.15L measured forward from the vertical plane at the rearmost heel location.

Clause 17. The sole structure according to any one of Clauses 1 to 16, wherein when the sole structure is supported upright with the bottom foot support surface thereof supported on the horizontal support surface in the unloaded condition, the sole structure defines a longitudinal distance L as a shortest direct distance between parallel vertical planes contacting a rearmost heel location of the sole structure and a forwardmost toe location of the sole structure, and wherein an entirety of the plate member is located rearward of a first forefoot plane parallel to the parallel vertical planes and located at 0.9L measured forward from the vertical plane at the rearmost heel location.

Clause 18. The sole structure according to any one of Clauses 1 to 17, wherein the first midsole component comprises a first foam member, wherein the second midsole component comprises a second foam member, and wherein the plate member is fixed directly to the first foam member at the first upper-facing surface thereof and directly to the second foam member at the second ground-facing surface thereof.

Clause 19. The sole structure according to any one of Clauses 1 to 18, wherein the first midsole component has a first hardness and the second midsole component has a second hardness, and wherein the first hardness is at least 4 Asker C durometer hardness points greater than the second hardness.

Clause 20. The sole structure according to any one of Clauses 1 to 18, wherein the first midsole component has a first hardness and the second midsole component has a second hardness, and wherein the first hardness is at least 6 Asker C durometer hardness points greater than the second hardness.

Clause 21. The sole structure according to any one of Clauses 1 to 20, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in the forefoot region of the sole structure at a lateral edge of the plate member, the sole structure defines: (a) a total vertical thickness T_{T} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, wherein T₁ is at least 65% of T_{T}, and T₂ is less than 35% of T_{T}.

Clause 22. The sole structure according to any one of Clauses 1 to 21, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in the forefoot region of the sole structure at a medial edge of the plate member, the sole structure defines: (a) a total vertical thickness T_{T} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, wherein T₁ is less than 40% of T_{T}, and T₂ is at least 55% of T_{T}.

Clause 23. The sole structure according to any one of Clauses 1 to 22, wherein when the sole structure is supported upright with the bottom foot support surface thereof supported on the horizontal support surface in the unloaded condition, the first ground-facing surface is substantially horizontal across a plane perpendicular to a longitudinal direction of the sole structure.

Clause 24. An article of footwear, comprising: (A) an upper; and (B) a sole structure according to any one of Clauses 1 to 23 engaged with the upper.

Clause 25. A sole structure for an article of footwear that includes a bottom foot support surface, the sole structure comprising: (A) a first midsole component including a first ground-facing surface and a first upper-facing surface located opposite the first ground-facing surface, wherein the first upper-facing surface defines a receptacle; (B) a second midsole component at least partially received in the receptacle, the second midsole component including a second ground-facing surface that faces the first upper-facing surface and a second upper-facing surface located opposite the second ground-facing surface; and (C) a plate member at least partially received in the receptacle and located between the first upper-facing surface and the second ground-facing surface, wherein when the sole structure is supported upright with the bottom foot support surface thereof supported on a horizontal support surface in an unloaded condition, a plantar support surface of the plate member located in a forefoot region of the sole structure has a downwardly lateral side-to-medial side tilt across at least 50% of a width dimension of the plate member in the forefoot region.

Clause 26. The sole structure according to Clause 25, wherein the plantar support surface of the plate member located in the forefoot region of the sole structure has the downwardly lateral side-to-medial side tilt across at least 75% of the width dimension of the plate member in the forefoot region.

Clause 27. The sole structure according to Clause 25, wherein the plantar support surface of the plate member located in the forefoot region of the sole structure has the downwardly lateral side-to-medial side tilt across at least 90% of the width dimension of the plate member in the forefoot region.

Clause 28. The sole structure according to any one of Clauses 25 to 27, wherein the plate member includes a twisted region in a midfoot region of the sole structure to produce the downwardly lateral side-to-medial side tilt at least in the forefoot region of the sole structure.

Clause 29. The sole structure according to any one of Clauses 25 to 27, wherein when the sole structure is supported upright with the bottom foot support surface thereof supported on the horizontal support surface in the unloaded condition, the plantar support surface of the plate member in at least a portion of a midfoot region of the sole structure has an upwardly lateral side-to-medial side tilt.

Clause 30. The sole structure according to Clause 29, wherein the plate member includes a twisted region in the midfoot region of the sole structure to transition from the upwardly lateral side-to-medial side tilt of the plantar support surface in the midfoot region to the downwardly lateral side-to-medial side tilt of the plantar support surface in the forefoot region.

Clause 31. The sole structure according to Clause 29 or 30, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, and wherein at a first plane parallel to the parallel vertical planes and located in the midfoot region of the sole structure, the upwardly lateral side-to-medial side tilt is at an angle of at least 5 degrees with respect to a horizontal line segment extending along the first plane.

Clause 32. The sole structure according to Clause 31, wherein the angle of the upwardly lateral side-to-medial side tilt at the first plane located in the midfoot region is at least 6 degrees.

Clause 33. The sole structure according to Clause 31, wherein the angle of the upwardly lateral side-to-medial side tilt at the first plane located in the midfoot region is at least 8 degrees.

Clause 34. The sole structure according to any one of Clauses 31 to 33, wherein the first plane in the midfoot region is located rearward of a second plane parallel to the parallel vertical planes and located at 0.5L measured forward from the vertical plane at the rearmost heel location, where L is the longitudinal distance.

Clause 35. The sole structure according to any one of Clauses 25 to 34, wherein a rearward end of the plate member includes a medial arm, a lateral arm, and a forwardly extending space separating the medial arm and the lateral arm.

Clause 36. The sole structure according to Clause 35, wherein when the sole structure is supported upright with the bottom foot support surface thereof supported on the horizontal support surface in the unloaded condition, the medial arm and the lateral arm of the plate member are at substantially the same height within at least a portion of a heel region of the sole structure.

Clause 37. The sole structure according to Clause 35, wherein when the sole structure is supported upright with the bottom foot support surface thereof supported on the horizontal support surface in the unloaded condition, a rearmost edge of the medial arm and a rearmost edge of the lateral arm are at substantially the same height.

Clause 38. The sole structure according to any one of Clauses 25 to 37, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, and wherein at a first plane parallel to the parallel vertical planes located at the forefoot region of the sole structure, the downwardly lateral side-to-medial side tilt is at an angle of at least 5 degrees with respect to a horizontal line segment extending along the first plane.

Clause 39. The sole structure according to Clause 38, wherein the angle of the downwardly lateral side-to-medial side tilt at the first plane located in the forefoot region is at least 6 degrees.

Clause 40. The sole structure according to Clause 38, wherein the angle of the downwardly lateral side-to-medial side tilt at the first plane located in the forefoot region is at least 10 degrees.

Clause 41. The sole structure according to any one of Clauses 38 to 40, wherein the first plane in the forefoot region is located rearward of a second plane parallel to the parallel vertical planes and located at 0.8L measured forward from the vertical plane at the rearmost heel location, where L is the longitudinal distance.

Clause 42. The sole structure according to any one of Clauses 25 to 41, wherein when the sole structure is supported upright with the bottom foot support surface thereof supported on the horizontal support surface in the unloaded condition, the sole structure defines a longitudinal distance L as a shortest direct distance between parallel vertical planes contacting a rearmost heel location of the sole structure and a forwardmost toe location of the sole structure, and wherein an entirety of the plate member is located forward of a first heel plane parallel to the parallel vertical planes and located at 0.15L measured forward from the vertical plane at the rearmost heel location.

Clause 43. The sole structure according to any one of Clauses 25 to 42, wherein when the sole structure is supported upright with the bottom foot support surface thereof supported on the horizontal support surface in the unloaded condition, the sole structure defines a longitudinal distance L as a shortest direct distance between parallel vertical planes contacting a rearmost heel location of the sole structure and a forwardmost toe location of the sole structure, and wherein an entirety of the plate member is located rearward of a first forefoot plane parallel to the parallel vertical planes and located at 0.9L measured forward from the vertical plane at the rearmost heel location.

Clause 44. The sole structure according to any one of Clauses 25 to 43, wherein the first midsole component comprises a first foam member, wherein the second midsole component comprises a second foam member, and wherein the plate member is fixed directly to the first foam member at the first upper-facing surface thereof and directly to the second foam member at the second ground-facing surface thereof.

Clause 45. The sole structure according to any one of Clauses 25 to 44, wherein the first midsole component has a first hardness and the second midsole component has a second hardness, and wherein the first hardness is at least 4 Asker C durometer hardness points greater than the second hardness.

Clause 46. The sole structure according to any one of Clauses 25 to 44, wherein the first midsole component has a first hardness and the second midsole component has a second hardness, and wherein the first hardness is at least 6 Asker C durometer hardness points greater than the second hardness.

Clause 47. The sole structure according to any one of Clauses 25 to 46, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in the forefoot region of the sole structure at a lateral edge of the plate member, the sole structure defines: (a) a total vertical thickness T_{T} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, wherein T₁ is at least 65% of T_{T}, and T₂ is less than 35% of T_{T}.

Clause 48. The sole structure according to any one of Clauses 25 to 47, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in the forefoot region of the sole structure at a medial edge of the plate member, the sole structure defines: (a) a total vertical thickness T_{T} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, wherein T₁ is less than 40% of T_{T}, and T₂ is at least 55% of T_{T}.

Clause 49. The sole structure according to any one of Clauses 25 to 48, wherein when the sole structure is supported upright with the bottom foot support surface thereof supported on the horizontal support surface in the unloaded condition, the first ground-facing surface is substantially horizontal across a plane perpendicular to a longitudinal direction of the sole structure.

Clause 50. An article of footwear, comprising: (A) an upper; and (B) a sole structure according to any one of Clauses 25 to 49 engaged with the upper.

Clause 51. A sole structure for an article of footwear that includes a bottom foot support surface, the sole structure comprising: (A) a first midsole component including a first ground-facing surface and a first upper-facing surface located opposite the first ground-facing surface, wherein the first midsole component has a first hardness at least at a first location in a forefoot region of the sole structure; and (B) a second midsole component including a second ground-facing surface that faces the first upper-facing surface and a second upper-facing surface located opposite the second ground-facing surface, wherein the second midsole component has a second hardness at least at a second location in the forefoot region of the sole structure, wherein the first hardness is at least 4 Asker C durometer hardness points greater than the second hardness, and wherein when the sole structure is supported upright with the bottom foot support surface thereof supported on a horizontal support surface in an unloaded condition, the first location and the second location at least partially align in a vertical direction of the sole structure.

Clause 52. The sole structure according to Clause 51, wherein the first hardness is at least 6 Asker C durometer hardness points greater than the second hardness.

Clause 53. The sole structure according to Clause 51 or 52, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in the forefoot region of the sole structure, the sole structure defines: (a) a total vertical thickness T_{T} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, wherein T₁ is at least 65% of T_{T}, and T₂ is less than 35% of T_{T}.

Clause 54. The sole structure according to any one of Clauses 51 to 53, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in the forefoot region of the sole structure, the sole structure defines: (a) a total vertical thickness T_{T} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, wherein T₁ is less than 40% of T_{T}, and T₂is at least 55% of T_{T}.

Clause 55. A sole structure for an article of footwear that includes a bottom foot support surface, the sole structure comprising: (A) a first midsole component including a first ground-facing surface and a first upper-facing surface located opposite the first ground-facing surface; and (B) a second midsole component including a second ground-facing surface that faces the first upper-facing surface and a second upper-facing surface located opposite the second ground-facing surface, wherein when the sole structure is supported upright with the bottom foot support surface thereof supported on a horizontal support surface in an unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in a forefoot region of the sole structure: (i) at a lateral of the sole structure, the sole structure defines: (a) a first total vertical thickness T_{T1} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, wherein T₁ is at least 65% of T_{T}, and T₂ is less than 35% of T_{T}, and (ii) at a medial side of the sole structure, the sole structure defines: (a) a second total vertical thickness T_{T2} measured from the first ground-facing surface to the second upper-facing surface, (b) a third midsole component vertical thickness T₃ measured from the first ground-facing surface to the first upper-facing surface, and (c) a fourth midsole component vertical thickness T₄measured from the second ground-facing surface to the second upper-facing surface, wherein T₃ is less than 40% of T_{T2}, and T₄ is at least 55% of T_{T2}.

Clause 56. The sole structure according to Clause 55, wherein at the first plane, the first midsole component has a first hardness and the second midsole component has a second hardness, wherein the first hardness is at least 4 Asker C durometer hardness points greater than the second hardness.

Clause 57. The sole structure according to Clause 56, wherein the first hardness is at least 6 Asker C durometer hardness points greater than the second hardness.

Clause 58. The sole structure according to any one of Clauses 51 to 57, further comprising a plate member at least partially located between the first upper-facing surface and the second ground-facing surface, wherein the plate member includes a plantar support surface having a lateral side edge and a medial side edge.

Clause 59. The sole structure according to Clause 58, wherein when the sole structure is supported upright with the bottom foot support surface thereof supported on the horizontal support surface in the unloaded condition, the plantar support surface of the plate member is tilted such that the lateral side edge is higher in the sole structure than the medial side edge at least in a portion of the forefoot region of the sole structure.

Clause 60. The sole structure according to Clause 58, wherein the plate member includes a twisted region in a midfoot region of the sole structure to produce tilt of the plantar support surface at least in the forefoot region.

Clause 61. The sole structure according to any one of Clauses 58 to 60, wherein when the sole structure is supported upright with the bottom foot support surface thereof supported on the horizontal support surface in the unloaded condition, the plantar support surface of the plate member is tilted such that the medial side edge is higher in the sole structure than the lateral side edge in at least a portion of a midfoot region of the sole structure.

Clause 62. The sole structure according to Clause 61, wherein the plate member includes a twisted region in the midfoot region of the sole structure to transition from the tilt of the plantar support surface in the midfoot region to the tilt of the plantar support surface in the forefoot region.

Clause 63. The sole structure according to any one of Clauses 58 to 62, wherein a rearward end of the plate member includes a medial arm, a lateral arm, and a forwardly extending space separating the medial arm and the lateral arm.

Clause 64. The sole structure according to Clause 63, wherein when the sole structure is supported upright with the bottom foot support surface thereof supported on the horizontal support surface in the unloaded condition, the medial arm and the lateral arm of the plate member are at substantially the same height within at least a portion of a heel region of the sole structure.

Clause 65. The sole structure according to Clause 63, wherein when the sole structure is supported upright with the bottom foot support surface thereof supported on the horizontal support surface in the unloaded condition, a rearmost edge of the medial arm and a rearmost edge of the lateral arm are at substantially the same height.

Clause 66. The sole structure according to any one of Clauses 58 to 65, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, and wherein at a first plane parallel to the parallel vertical planes located in the forefoot region of the sole structure: a first angle of at least 5 degrees is defined between: (i) a first line segment extending along the first plane from the medial side edge of the plantar support surface to the lateral side edge of the plantar support surface and (ii) a horizontal line segment extending along the first plane through a junction of the first line segment and the medial side edge.

Clause 67. The sole structure according to Clause 66, wherein the first angle is at least 6 degrees.

Clause 68. The sole structure according to Clause 66, wherein the first angle is at least 10 degrees.

Clause 69. The sole structure according to any one of Clauses 66 to 68, wherein the first plane in the forefoot region is located rearward of a second plane parallel to the parallel vertical planes located at 0.8L measured forward from the vertical plane at the rearmost heel location, where L is the longitudinal distance.

Clause 70. The sole structure according to any one of Clauses 58 to 69, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, and wherein at a first plane parallel to the parallel vertical planes located in a midfoot region of the sole structure: a second angle of at least 5 degrees is defined between: (i) a first line segment extending along the first plane in the midfoot region from the medial side edge of the plantar support surface to the lateral side edge of the plantar support surface and (ii) a horizontal line segment extending along the first plane in the midfoot region and through a junction of the first line segment and the lateral side edge.

Clause 71. The sole structure according to Clause 70, wherein the second angle is at least 6 degrees.

Clause 72. The sole structure according to Clause 70, wherein the second angle is at least 10 degrees.

Clause 73. The sole structure according to any one of Clauses 70 to 72, wherein the first plane in the midfoot region of the sole structure is located rearward of a second plane parallel to the parallel vertical planes located at 0.5L measured forward from the vertical plane at the rearmost heel location, where L is the longitudinal distance.

Clause 74. The sole structure according to any one of Clauses 58 to 73, wherein when the sole structure is supported upright with the bottom foot support surface thereof supported on the horizontal support surface in the unloaded condition, the sole structure defines a longitudinal distance L as a shortest direct distance between parallel vertical planes contacting a rearmost heel location of the sole structure and a forwardmost toe location of the sole structure, and wherein an entirety of the plate member is located forward of a first heel plane parallel to the parallel vertical planes and located at 0.15L measured forward from the vertical plane at the rearmost heel location.

Clause 75. The sole structure according to any one of Clauses 58 to 74, wherein when the sole structure is supported upright with the bottom foot support surface thereof supported on the horizontal support surface in the unloaded condition, the sole structure defines a longitudinal distance L as a shortest direct distance between parallel vertical planes contacting a rearmost heel location of the sole structure and a forwardmost toe location of the sole structure, and wherein an entirety of the plate member is located rearward of a first forefoot plane parallel to the parallel vertical planes and located at 0.9L measured forward from the vertical plane at the rearmost heel location.

Clause 76. The sole structure according to any one of Clauses 58 to 75, wherein the first midsole component comprises a first foam member, wherein the second midsole component comprises a second foam member, and wherein the plate member is fixed directly to the first foam member at the first upper-facing surface thereof and directly to the second foam member at the second ground-facing surface thereof.

Clause 77. The sole structure according to any one of Clauses 51 to 75, wherein the first midsole component comprises a first foam member, and wherein the second midsole component comprises a second foam member.

Clause 78. The sole structure according to Clause 76 or 77, wherein the first foam member has a secant stiffness of 230 N/mm ± 10%, and/or wherein the second foam member has a secant stiffness of 185 N/mm ± 10%.

Clause 79. The sole structure according to any one of Clauses 76 to 78, wherein the first foam member has an energy return in a range of 5 to 6.5 Joules, and/or wherein the second foam member has an energy return in a range of 6.5 to 8 Joules.

Clause 80. The sole structure according to any one of Clauses 76 to 79, wherein the first foam member has a specific gravity in a range of 0.175 to 0.25, and/or wherein the second foam member has a specific gravity of less than 0.175.

Clause 81. The sole structure according to any one of Clauses 51 to 80, wherein when the sole structure is supported upright with the bottom foot support surface thereof supported on the horizontal support surface in the unloaded condition, the first ground-facing surface is substantially horizontal across a plane perpendicular to a longitudinal direction of the sole structure.

Clause 82. An article of footwear, comprising: (A) an upper; and (B) a sole structure according to any one of Clauses 51 to 81 engaged with the upper.

### Conclusion

The present technology is disclosed above and in the accompanying drawings with reference to a variety of embodiments. The purpose served by the disclosure, however, is to provide an example of the various features and concepts related to this technology, not to limit the scope of the claimed invention. One skilled in the relevant art will recognize that numerous variations and modifications may be made to the embodiments described above without departing from the scope of the presently claimed invention, as defined by the appended claims.

What is claimed is:

1. A sole structure for an article of footwear that includes a bottom foot support surface, the sole structure comprising:
a first midsole component including a first ground-facing surface and a first upper-facing surface located opposite the first ground-facing surface, wherein the first upper-facing surface defines a receptacle;
a second midsole component at least partially received in the receptacle, the second midsole component including a second ground-facing surface that faces the first upper-facing surface and a second upper-facing surface located opposite the second ground-facing surface; and
a plate member at least partially received in the receptacle and located between the first upper-facing surface and the second ground-facing surface, wherein the plate member includes a plantar support surface having a lateral side edge and a medial side edge,
wherein when the sole structure is supported upright with the bottom foot support surface thereof supported on a horizontal support surface in an unloaded condition, the plantar support surface of the plate member is tilted such that the lateral side edge is higher in the sole structure than the medial side edge at least in a portion of a forefoot region of the sole structure.

2. The sole structure according to claim 1, wherein when the sole structure is supported upright with the bottom foot support surface thereof supported on the horizontal support surface in the unloaded condition, the plantar support surface of the plate member is tilted such that the medial side edge is higher in the sole structure than the lateral side edge in at least a portion of a midfoot region of the sole structure.

3. The sole structure according to claim 2, wherein the plate member includes a twisted region in the midfoot region of the sole structure to transition from the tilt of the plantar support surface in the midfoot region to the tilt of the plantar support surface in the forefoot region.

4. The sole structure according to claim 3, wherein a rearward end of the plate member includes a medial arm, a lateral arm, and a forwardly extending space separating the medial arm and the lateral arm.

5. The sole structure according to claim 4, wherein when the sole structure is supported upright with the bottom foot support surface thereof supported on the horizontal support surface in the unloaded condition, a rearmost edge of the medial arm and a rearmost edge of the lateral arm are at substantially the same height.

6. The sole structure according to claim 2, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, and wherein at a first plane parallel to the parallel vertical planes located in the forefoot region of the sole structure: a first angle of at least 5 degrees is defined between: (i) a first line segment extending along the first plane from the medial side edge of the plantar support surface to the lateral side edge of the plantar support surface and (ii) a horizontal line segment extending along the first plane through a junction of the first line segment and the medial side edge.

7. The sole structure according to claim 6, wherein the first angle is at least 10 degrees.

8. The sole structure according to claim 6, wherein the first plane in the forefoot region is located rearward of a second plane parallel to the parallel vertical planes located at 0.8L measured forward from the vertical plane at the rearmost heel location, where L is the longitudinal distance.

9. The sole structure according to claim 6, wherein when the sole structure is supported upright with the bottom foot support surface thereof supported on the horizontal support surface in the unloaded condition, at a first plane parallel to the parallel vertical planes located in a midfoot region of the sole structure: a second angle of at least 5 degrees is defined between: (i) a first line segment extending along the first plane in the midfoot region from the medial side edge of the plantar support surface to the lateral side edge of the plantar support surface and (ii) a horizontal line segment extending along the first plane in the midfoot region and through a junction of the first line segment and the lateral side edge.

10. The sole structure according to claim 9, wherein the first plane in the midfoot region of the sole structure is located rearward of a second plane parallel to the parallel vertical planes located at 0.5L measured forward from the vertical plane at the rearmost heel location, where L is the longitudinal distance.

11. The sole structure according to claim 1, wherein when the sole structure is supported upright with the bottom foot support surface thereof supported on the horizontal support surface in the unloaded condition, the sole structure defines a longitudinal distance L as a shortest direct distance between parallel vertical planes contacting a rearmost heel location of the sole structure and a forwardmost toe location of the sole structure, and wherein an entirety of the plate member is located: (A) forward of a first heel plane parallel to the parallel vertical planes and located at 0.15L measured forward from the vertical plane at the rearmost heel location, and (B) rearward of a first forefoot plane parallel to the parallel vertical planes and located at 0.9L measured forward from the vertical plane at the rearmost heel location.

12. The sole structure according to claim 1, wherein the first midsole component comprises a first foam member, wherein the second midsole component comprises a second foam member, and wherein the plate member is fixed directly to the first foam member at the first upper-facing surface thereof and directly to the second foam member at the second ground-facing surface thereof.

13. The sole structure according to claim 1, wherein the first midsole component has a first hardness and the second midsole component has a second hardness, and wherein the first hardness is at least 4 Asker C durometer hardness points greater than the second hardness.

14. The sole structure according to claim 1, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in the forefoot region of the sole structure, the sole structure defines: (a) a total vertical thickness T_{T} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, and wherein: (A) at a lateral edge of the plate member, T₁ is at least 65% of T_{T} and T₂ is less than 35% of T_{T} and (B) at a medial edge of the plate member, T₁ is less than 40% of T_{T} and T₂ is at least 55% of T_{T}.

15. A sole structure for an article of footwear that includes a bottom foot support surface, the sole structure comprising:
a first midsole component including a first ground-facing surface and a first upper-facing surface located opposite the first ground-facing surface, wherein the first upper-facing surface defines a receptacle;
a second midsole component at least partially received in the receptacle, the second midsole component including a second ground-facing surface that faces the first upper-facing surface and a second upper-facing surface located opposite the second ground-facing surface; and
a plate member at least partially received in the receptacle and located between the first upper-facing surface and the second ground-facing surface, wherein when the sole structure is supported upright with the bottom foot support surface thereof supported on a horizontal support surface in an unloaded condition, a plantar support surface of the plate member located in a forefoot region of the sole structure has a downwardly lateral side-to-medial side tilt across at least 50% of a width dimension of the plate member in the forefoot region.

16. The sole structure according to claim 15, wherein the plantar support surface of the plate member located in the forefoot region of the sole structure has the downwardly lateral side-to-medial side tilt across at least 90% of the width dimension of the plate member in the forefoot region.

17. The sole structure according to claim 15, wherein when the sole structure is supported upright with the bottom foot support surface thereof supported on the horizontal support surface in the unloaded condition, the plantar support surface of the plate member in at least a portion of a midfoot region of the sole structure has an upwardly lateral side-to-medial side tilt.

18. The sole structure according to claim 17, wherein the plate member includes a twisted region in the midfoot region of the sole structure to transition from the upwardly lateral side-to-medial side tilt of the plantar support surface in the midfoot region to the downwardly lateral side-to-medial side tilt of the plantar support surface in the forefoot region.

19. The sole structure according to claim 18, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, and wherein: (A) at a first plane parallel to the parallel vertical planes located in the midfoot region of the sole structure, the upwardly lateral side-to-medial side tilt is at an angle of at least 5 degrees with respect to a horizontal line segment extending along the first plane, and (B) at a first plane parallel to the parallel vertical planes located at the forefoot region of the sole structure, the downwardly lateral side-to-medial side tilt is at an angle of at least 5 degrees with respect to a horizontal line segment extending along the first plane.

20. The sole structure according to claim 15, wherein when the sole structure is supported upright with the bottom foot support surface thereof supported on the horizontal support surface in the unloaded condition, the sole structure defines a longitudinal distance as a shortest direct distance between parallel vertical planes contacting a rearmost heel location of the sole structure and a forwardmost toe location of the sole structure, wherein at a first plane parallel to the parallel vertical planes located in the forefoot region of the sole structure, the sole structure defines: (a) a total vertical thickness T_{T} measured from the first ground-facing surface to the second upper-facing surface, (b) a first midsole component vertical thickness T₁ measured from the first ground-facing surface to the first upper-facing surface, and (c) a second midsole component vertical thickness T₂ measured from the second ground-facing surface to the second upper-facing surface, and wherein: (A) at a lateral edge of the plate member, T₁ is at least 65% of T_{T} and T₂ is less than 35% of T_{T} and (B) at a medial edge of the plate member, T₁ is less than 40% of T_{T} and T₂ is at least 55% of T_{T}.
